(19) United States
(12) Patent Application Publication
(10) Pub. No.: US 2025/0112004 A1
(43) Pub. Date: Apr. 3, 2025

(54) KEYCAP LIFTING MECHANISM AND KEYSWITCH STRUCTURE

(71) Applicant: DARFON ELECTRONICS CORP., Taoyuan City (TW)

(72) Inventors: Po-Wei Tsai, Taoyuan City (TW); Hsun-Kun Peng, Taoyuan City (TW); Po-Min Huang, Taoyuan City (TW)

(73) Assignee: DARFON ELECTRONICS CORP., Taoyuan City (TW)

(21) Appl. No.: 18/896,971

(22) Filed: Sep. 26, 2024

Related U.S. Application Data
(60) Provisional application No. 63/540,942, filed on Sep. 28, 2023.

(30) Foreign Application Priority Data
Sep. 25, 2024 (TW) 113136264

(51) Int. Cl. H01H 13/04; H01H 3/12; H01H 13/52

(52) U.S. Cl. CPC H01H 13/04; H01H 3/122; H01H 13/52

(57) ABSTRACT

A keycap support mechanism increases the stability of supporting a keycap through structure designs of supports. Two supports are pivotally connected around a pivot axis. One of the supports includes a support body and a reinforcement part embedded into the support body. The elastic modulus of the reinforcement part is greater than the elastic modulus of the support body. In an embodiment, the reinforced support includes Z-shaped bending structure extending parallel to the pivotal axis. In another embodiment, the reinforced support has a sliding shaft and a sliding hole formed beside the sliding shaft. The reinforced support is slidably and rotatably connected to the keycap through the sliding shaft. The reinforcement part surrounds the sliding hole and goes through the sliding shaft. A keyswitch structure includes a base plate, a keycap, and any of the above keycap support mechanisms. The keycap support mechanism supports the keycap above the base plate.

### CROSS REFERENCE TO RELATED APPLICATIONS

This application claims the benefit of U.S. Provisional Application No. 63/540,942, filed on Sep. 28, 2023. The content of the application is incorporated herein by reference.

### BACKGROUND OF THE INVENTION

### 1. Field of the Invention

The present invention relates to a keyswitch structure, and more particularly to a keyswitch structure with reinforced support and a keycap lifting mechanism thereof.

### 2. Description of the Prior Art

With the miniaturization of keyswitch structures, the space available for each component is greatly reduced, and the structural strength of the components is difficult to maintain, resulting in a decrease in the stability of movement of the entire keyswitch structure. For example, the stability of the transmission between a support and another component (such as another support, a keycap or a base plate, etc.) decreases, and the stability of the support supporting the keycap also decreases. For another example, after the keyswitch structure is used for a period of time or during the assembly process of the supports, it may cause some permanent deformation of the supports, which affects the stability of movement and even renders the keyswitch structure unusable.

### SUMMARY OF THE INVENTION

In view of the problems in the prior art, an objective of the invention is to provide a keycap lifting mechanism, which has a reinforced support, thereby improving the overall strength and movement stability of the keycap lifting mechanism.

A keycap lifting mechanism of an embodiment according to the invention includes a first support and a second support. The first support includes a support body and a reinforcement part. The reinforcement part is embedded into the support body. An elastic modulus of the reinforcement part is greater than an elastic modulus of the support body. The second support and the first support are pivotally connected around a pivot axis. Therein, the reinforcement part includes a Z-shaped bending structure. The Z-shaped bending structure extends parallel to the pivot axis. Thereby, the structural strength of the first support has been improved due to the existence of the reinforcement part; besides, that the reinforcement part has a Z-shaped bending structure further enhances the reinforcing effect of the reinforcement part on the first support. Furthermore, because the Z-shaped bending structure extends parallel to the pivot axis, or in other words, the Z-shaped bending structure extends parallel to the pivot axis with a Z-shaped cross-section, the ability of the reinforcement part to resist deflection along the pivot axis is increased. Therefore, due to the existence of the reinforcement part, the overall strength and movement stability of the keycap lifting mechanism can be improved.

Another objective of the invention is to provide a keycap structure, of which a keycap lifting mechanism has a reinforced support, thereby improving the overall strength and movement stability of the keycap structure.

A keycap structure of an embodiment according to the invention includes a base plate, a keycap, and a keycap lifting mechanism. The keycap lifting mechanism supports the keycap above the base plate in a vertical direction. The keycap lifting mechanism includes a first support and a second support. The first support includes a support body and a reinforcement part. The reinforcement part is embedded into the support body. An elastic modulus of the reinforcement part is greater than an elastic modulus of the support body. The second support and the first support are pivotally connected around a pivot axis. Therein, the reinforcement part includes a Z-shaped bending structure. The Z-shaped bending structure extends parallel to the pivot axis. Similarly, the structural strength of the first support has been improved due to the existence of the reinforcement part; besides, that the reinforcement part has a Z-shaped bending structure further enhances the reinforcing effect of the reinforcement part on the first support. Furthermore, because the Z-shaped bending structure extends parallel to the pivot axis, or in other words, the Z-shaped bending structure extends parallel to the pivot axis with a Z-shaped cross-section, the ability of the reinforcement part to resist deflection along the pivot axis is increased. Therefore, because the keycap lifting mechanism has the reinforcement part, the overall strength and movement stability of the keycap structure can be improved.

Another objective of the invention is to provide a keycap lifting mechanism, which has a reinforced support, thereby improving the overall strength and movement stability of the keycap lifting mechanism.

A keycap lifting mechanism of an embodiment according to the invention includes a first support and a second support. The first support includes a support body and a reinforcement part. The reinforcement part is embedded into the support body. An elastic modulus of the reinforcement part is greater than an elastic modulus of the support body. The support body has a sliding shaft and a sliding hole formed beside the sliding shaft. The reinforcement part surrounds the sliding hole and goes through the sliding shaft. The second support and the first support are pivotally connected around a pivot axis. Thereby, the structural strength of the first support has been improved due to the existence of the reinforcement part; besides, the reinforcement part strengthens the structural strength of the first support at the sliding hole and the sliding shaft, and can also improve the stability of the mutual linkage between the first support and the keycap. Therefore, due to the existence of the reinforcement part, the overall strength and movement stability of the keycap lifting mechanism can be improved.

Another objective of the invention is to provide a keycap structure, of which a keycap lifting mechanism has a reinforced support, thereby improving the overall strength and movement stability of the keycap structure.

A keycap structure of an embodiment according to the invention includes a base plate, a keycap, and a keycap lifting mechanism. The keycap lifting mechanism supports the keycap above the base plate in a vertical direction. The keycap lifting mechanism includes a first support and a second support. The first support includes a support body and a reinforcement part. The reinforcement part is embedded into the support body. An elastic modulus of the reinforcement part is greater than an elastic modulus of the support body. The support body has a sliding shaft and a sliding hole formed beside the sliding shaft. The reinforcement part surrounds the sliding hole and goes through the sliding shaft. The first support is slidably and rotatably connected to the keycap through the sliding shaft. The second support and the first support are pivotally connected around a pivot axis. Thereby, the structural strength of the first support has been improved due to the existence of the reinforcement part; besides, the reinforcement part strengthens the structural strength of the first support at the sliding hole and the sliding shaft, and can also improve the stability of the mutual linkage between the first support and the keycap. Therefore, because the keycap lifting mechanism has the reinforcement part, the overall strength and movement stability s of the keycap structure can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partially-exploded view of a keyswitch structure according to a first embodiment.

FIG. 2 is an exploded view of the keyswitch structure in FIG. 1.

FIG. 3 is a schematic diagram illustrating the first support in FIG. 2 from another viewpoint.

FIG. 4 is an exploded view of the first support in FIG. 3.

FIG. 5 is a sectional view of the first support in FIG. 3 along the line X1-X1.

FIG. 6 is an enlarged view of the circle A in FIG. 3 from another viewpoint.

FIG. 7 is a sectional view of the first support in FIG. 3 along the line Y1-Y1.

FIG. 8 is a side view of the first support in FIG. 3.

FIG. 9 is a top view of the first support in FIG. 3.

FIG. 10 is a sectional view of the first support in FIG. 3 along the line Z1-Z1.

FIG. 11 is a schematic diagram illustrating the second support in FIG. 2 from another viewpoint.

FIG. 12 is an exploded view of the second support in FIG. 11.

FIG. 13 is an enlarged view of the circle B in FIG. 11.

FIG. 14 is a top view of the first support, the second support, and a base plate of the keyswitch structure in FIG. 1.

FIG. 15 is a sectional view of the keyswitch structure in FIG. 1, of which the position of the cutting plane is shown as the line W1-W1 of FIG. 14.

FIG. 16 is a top view of a switch circuit board in FIG. 2.

FIG. 17 is a schematic diagram illustrating the second support in FIG. 11 from another viewpoint.

FIG. 18 is a partially-exploded view of a keyswitch structure according to a second embodiment.

FIG. 19 is an exploded view of the keyswitch structure in FIG. 18.

FIG. 20 is a schematic diagram illustrating the first support in FIG. 19 from another viewpoint.

FIG. 21 is an exploded view of the first support in FIG. 20.

FIG. 22 is a sectional view of the first support in FIG. 20 along the line X3-X3.

FIG. 23 is an enlarged view of the circle C in FIG. 20 from another viewpoint.

FIG. 24 is a sectional view of the first support in FIG. 20 along the line Y3-Y3.

FIG. 25 is a side view of the first support in FIG. 20.

FIG. 26 is a top view of the first support in FIG. 20.

FIG. 27 is a sectional view of the first support in FIG. 20 along the line Z3-Z3.

FIG. 28 is a schematic diagram illustrating the second support in FIG. 19 from another viewpoint.

FIG. 29 is an exploded view of the second support in FIG. 28.

FIG. 30 is an enlarged view of the circle D in FIG. 28.

FIG. 31 is a top view of the first support, the second support, and a base plate of the keyswitch structure in FIG. 18.

FIG. 32 is a sectional view of the keyswitch structure in FIG. 18, of which the position of the cutting plane is shown as the line W3-W3 of FIG. 31.

FIG. 33 is a top view of a switch circuit board in FIG. 19.

FIG. 34 is a schematic diagram illustrating the second support in FIG. 28 from another viewpoint.

FIG. 35 is a partially-exploded view of a keyswitch structure according to a third embodiment.

FIG. 36 is an exploded view of the keyswitch structure in FIG. 35.

FIG. 37 is a schematic diagram illustrating the first support in FIG. 36 from another viewpoint.

FIG. 38 is an exploded view of the first support in FIG. 37.

FIG. 39 is a sectional view of the first support in FIG. 37 along the line X5-X5.

FIG. 40 is an enlarged view of the circle E in FIG. 37 from another viewpoint.

FIG. 41 is a sectional view of the first support in FIG. 37 along the line Y5-Y5.

FIG. 42 is a side view of the first support in FIG. 37.

FIG. 43 is a top view of the first support in FIG. 37.

FIG. 44 is a sectional view of the first support in FIG. 37 along the line Z5-Z5.

FIG. 45 is a schematic diagram illustrating the second support in FIG. 36 from another viewpoint.

FIG. 46 is an exploded view of the second support in FIG. 45.

FIG. 47 is an enlarged view of the circle F in FIG. 45.

FIG. 48 is a side view of the second support in FIG. 45.

FIG. 49 is a top view of the first support, the second support, and a base plate of the keyswitch structure in FIG. 35.

FIG. 50 is a top view of a switch circuit board in FIG. 36.

FIG. 51 is a schematic diagram illustrating the first support and the second support from another viewpoint.

### DETAILED DESCRIPTION

Directional terms mentioned in the following embodiments, such as up, down, left, right, front or back, etc., are only for reference to the directions in the attached drawings. The prefixes of component names, such as first, second, . . . , etc., are only used to distinguish components and facilitate description, and do not impose other restrictions on the components themselves; furthermore, components with the same prefix in various embodiments do not necessarily correspond. The correspondence of components in each embodiment should still depends on the specific structure described in each embodiment.

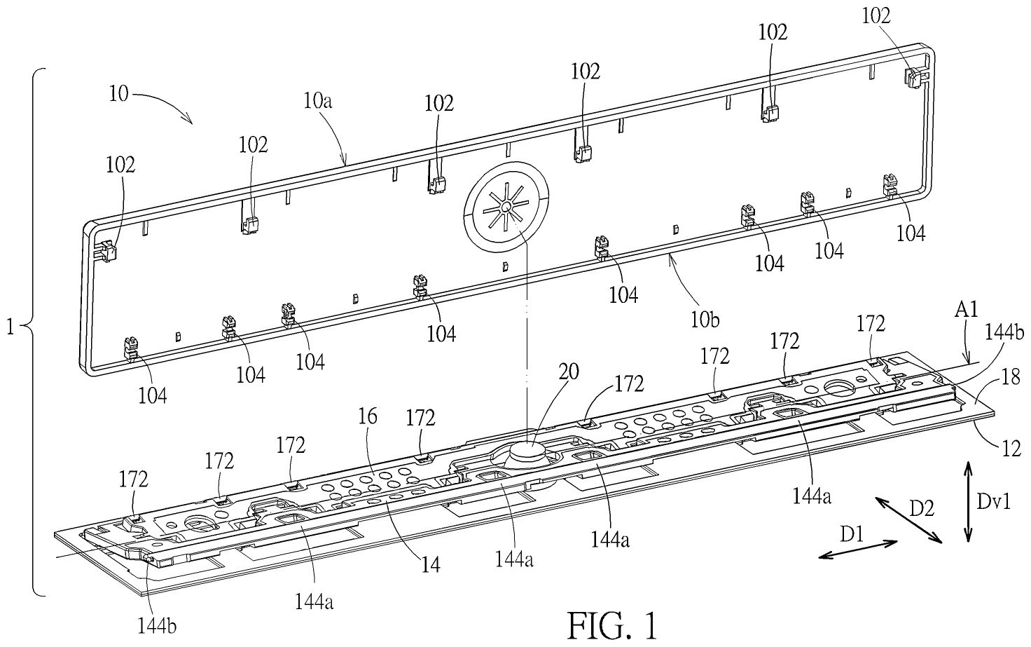

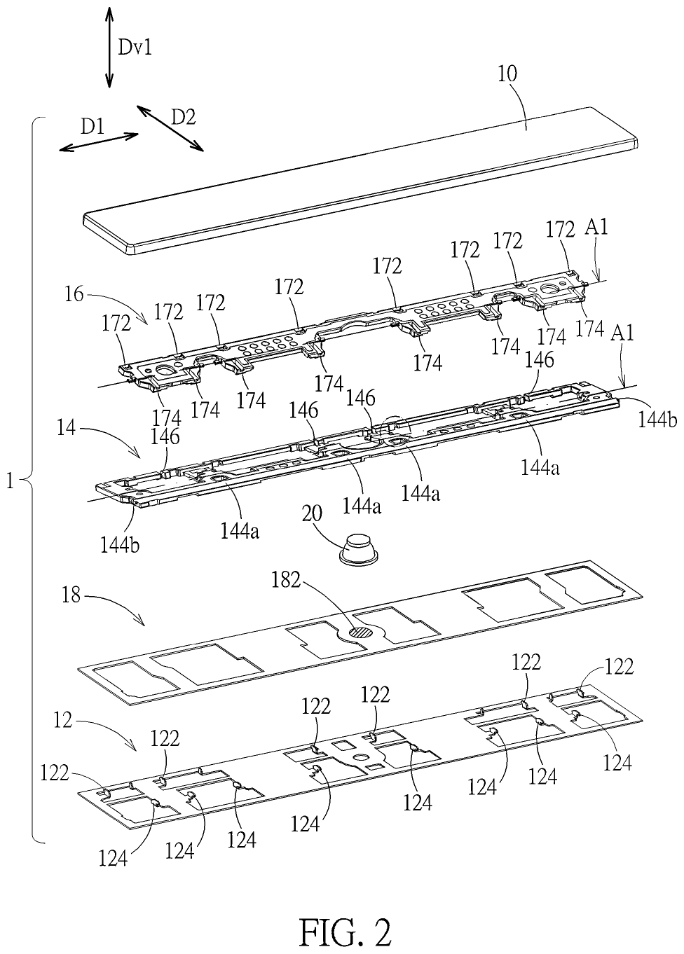

Please refer to FIG. 1 and FIG. 2. A keyswitch structure 1 according to a first embodiment is a long rectangular keyswitch structure, which has a long side direction D1 and a short side direction D2 (both are indicated by double-headed arrows in the figures). The long side direction D1 is perpendicular to the short side direction D2. In practice, the keyswitch structure 1 can be but is not limited to a space key. The keyswitch structure 1 includes a keycap 10, a base plate 12, a first support 14, a second support 16, a switch circuit board 18, and an elastic dome 20. The keycap 10 is disposed above the base plate 12. The first support 14 and the second support 16 are pivotally connected around a pivot axis A1 (indicated by a chain line). The pivot axis A1 is parallel to the long side direction D1. The first support 14 and the second support 16 are connected to the keycap 10 and the base plate 12 to support the keycap 10 above the base plate 12, so that the keycap 10 can move (e.g. moving up and down or parallel to a vertical direction Dv1) relative to the base plate 12 through the first support 14 and the second support 16. The vertical direction Dv1 (indicated by a double-headed arrow in the figures) is perpendicular to the long side direction D1 and the short side direction D2. The switch circuit board 18 is placed on the base plate 12. The switch circuit board 18 can be but not limited to a membrane circuit board, and has a switch 182 (shown as a circle filled with oblique lines in the figure), roughly corresponding to the center of the keycap 10. The elastic dome 20 corresponds to the switch 182 and is disposed on switch circuit board 18 and below the keycap 10. The keycap 10 can be pressed to move toward the base plate 12, and then squeezes the elastic dome 20 to trigger the switch 182 downward. Therefore, in logic, the combination of the first support 14 and the second support 16 or the combination of the first support 14, the second support 16, and the base plate 12 can be regarded as a keycap lifting mechanism.

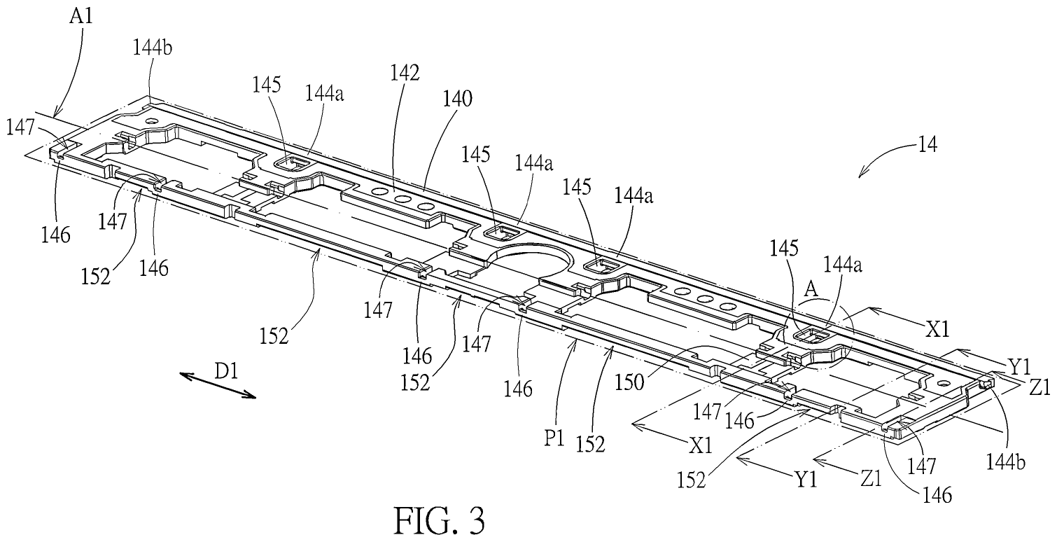

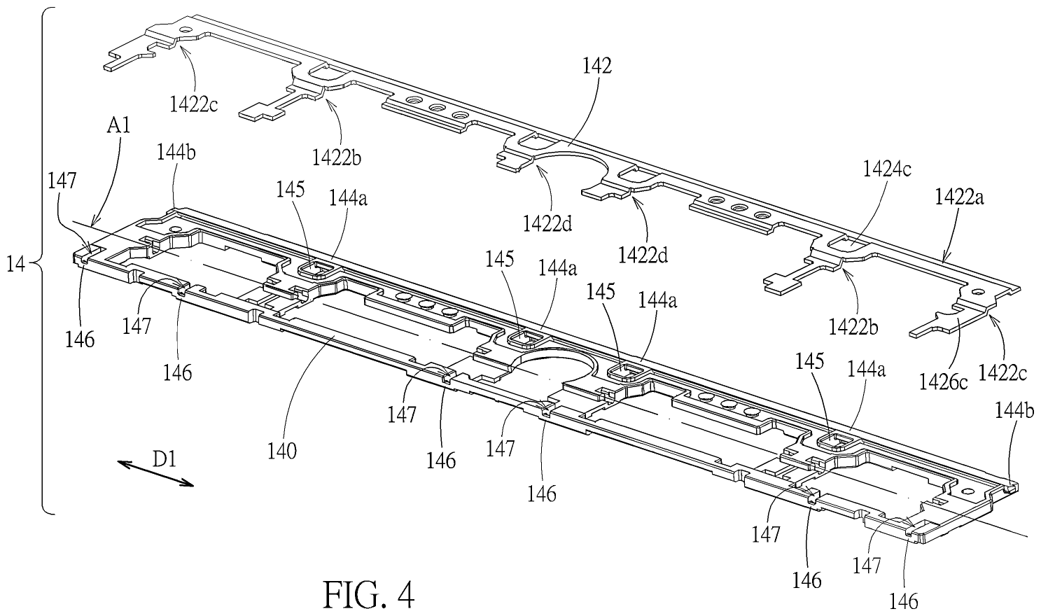

For further details, please refer to FIG. 3 and FIG. 4. The first support 14 includes a first support body 140 and a first reinforcement part 142. The first reinforcement part 142 is embedded into the first support body 140. An elastic modulus of the first reinforcement part 142 is greater than an elastic modulus of the first support body 140. Thereby, the first reinforcement part 142 has the effect of reinforcing the structure of the first support 14. Furthermore, in the first embodiment, the first support 14 as a whole show a frame structure, and mainly includes a rectangular outer frame portion and a plurality intermediate connecting portions which connect two long sides (parallel to the long side direction D1) of the rectangular outer frame portion inside the rectangular outer frame portion. The first support 14 is connected to the keycap 10 through one of the long sides, and is connected to the base plate 12 through the other long side. The first reinforcement part 142 as a whole includes a long arm and a plurality of support arms protruding from the long arm perpendicular to the long arm. The long arm is located in one of the long sides of the rectangular outer frame portion (i.e., the long side that is connected to the keycap 10) and extends parallel to the pivot axis A1. The plurality of support arms extend in the plurality of intermediate connecting portions and two short sides of the outer frame portion. The first reinforcement part 142 includes a plurality of Z-shaped bending structures 1422a˜d, which all extend parallel to the pivot axis A1 (or in other words, the Z-shaped bending structures 1422a˜d extend parallel to the pivot axis A1 with a Z-shaped cross-section), thereby increasing the ability of the first reinforcement part 142 to resist deflection along the pivot axis A1, and also enhancing the linkage of the keycap lifting mechanism (including the mutually pivoted first support 14 and second support 16) in the long side direction D1 (or in other words, increasing the efficiency of transmitting force in the long side direction D1). Therein, the Z-shaped bending structure 1422a is located on the long arm, the Z-shaped bending structures 1422b˜d are located on the plurality of support arms, and the support arms, including the Z-shaped bending structures 1422b and 1422c, also extend to the other long side of the rectangular outer frame portion (i.e., the long side that is connected to the base plate 12), which improves the structural strength of this long side. The Z-shaped bending structures 1422a˜d all can further enhance the structural reinforcing effect of the first reinforcement part 142 on the first support body 140. In addition, in practice, the first reinforcement part 142 can also be designed to exist on the both long sides of the rectangular outer frame portion at the same time.

Furthermore, as shown by FIG. 1 and FIG. 3, the first support body 140 (or the first support 14) has a plurality of sliding shafts 144a and 144b (on the long side of the outer frame portion that is connected to the keycap 10) and a plurality of base shafts 146 (on the long side of the outer frame portion that is connected to the base plate 12). A sliding hole 145 is formed beside the sliding shaft 144a. A base hole 147 is formed beside the base shaft 146. The first support 14 is slidably and rotatably connected to the keycap 10 (or sliding hooks 102 thereof) through the sliding shafts 144a and 144b, and the sliding hooks 102 extend into the sliding holes 145 correspondingly. The first support 14 is rotatably connected to the base plate 12 (or base hooks 122 thereof) through the base shafts 146; therein, the base shafts 146 are rotatably hooked by the base hooks 122 correspondingly, and the base hooks 122 extend into the base holes 147 correspondingly.

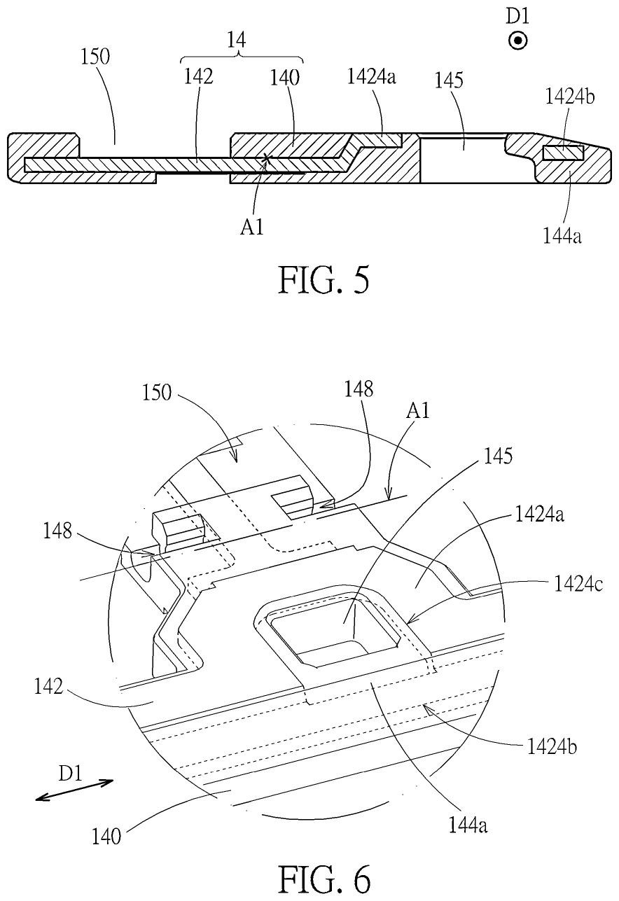

Please refer to FIG. 3 to FIG. 6; in FIG. 6, the hidden profile of the first reinforcement part 142 is partially shown in dashed lines. The first reinforcement part 142 surrounds the sliding hole 145 and goes through the sliding shaft 144a, thereby enhancing the structural strength of the first support 14 at the sliding hole 145 and the sliding shaft 144a, and also improving the stability of the mutual linkage between the first support 14 and the keycap 10. In the first embodiment, the first reinforcement part 142 uses the Z-shaped bending structure 1422a to achieve the above structural configuration, but it is not limited to thereto in practice. Therein, the Z-shaped bending structure 1422a is located on a side fringe of the first reinforcement part 142 and is distributed throughout the side fringe. The Z-shaped bending structure 1422a includes a first plate portion 1424a and a second plate portion 1424b at the circle A in FIG. 3. The first plate portion 1424a and the second plate portion 1424b are not coplanar. The first plate portion 1424a and the second plate portion 1424b are connected to form a through hole 1424c. The sliding hole 145 is located inside the through hole 1424c. The second plate portion 1424b goes through the sliding shaft 144a. Furthermore, as shown by FIG. 5, the sliding shaft 144a extends parallel to pivot axis A1 with a non-rectangular cross-section. In the first embodiment, the non-rectangular cross-section is roughly trapezoidal, so that the thickness of the sliding shaft 144a gradually decreases in the direction away from pivot axis A1, which can effectively reduce the degree of the structural interference between the sliding shaft 144a and the keycap 10. That the second plate portion 1424b goes through the sliding shaft 144a can compensate for the reduction in the structural strength of the sliding shaft 144a caused by the gradual decrease in thickness, and can even further enhance the structural strength of the sliding shaft 144a.

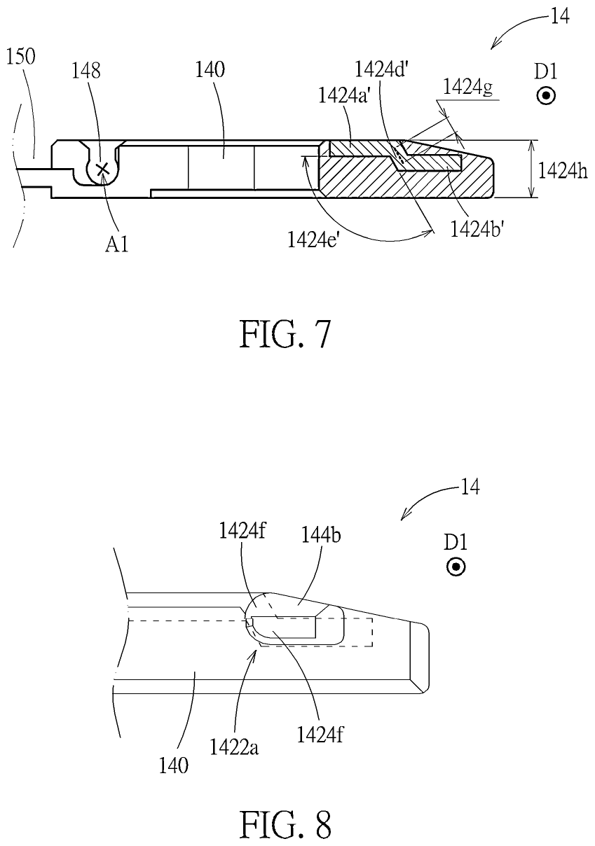

On the other hand, the first support body 140 has a side fringe (i.e., the long side that is connected to the keycap 10), of which the thickness gradually decreases in the direction away from the pivot axis A1, which can effectively reduce the degree of the structural interference between the first support body 140 and the keycap 10. The Z-shaped bending structure 1422a can extend perpendicular to the pivot axis A1 into the side fringe through its structural bending characteristics, which can compensate for the reduction in the structural strength of the side fringe due to the gradual decrease in thickness, and can even further enhance the structural strength of the side fringe. Furthermore, take the first support 14 at the line Y1-Y1 in FIG. 3 as an example. As shown by FIG. 7, the Z-shaped bending structure 1422a includes a first plate portion 1424a′, a second plate portion 1424b′, and a connecting plate portion 1424d′. The first plate portion 1424a′, the second plate portion 1424b′, and the connecting plate portion 1424d′ extend parallel to the pivot axis A1 and are not coplanar. The first plate portion 1424a′ and the second plate portion 1424b′ are connected to opposite sides of the connecting plate portion 1424d′. The first plate portion 1424a′ is exposed from the first support body 140. The second plate portion 1424b′ extends in the side fringe. Furthermore, in the first embodiment, an included angle 1424e′ is formed by the first plate portion 1424a′ and the connecting plate portion 1424d′ (i.e. a bending angle). The included angle 1424e′ is greater than 90 degrees, e.g., 120 degrees. However, it is not limited thereto in practice. For example, the included angle 1424e′ is between 40 degrees and 90 degrees. This description about the bending angle also applies to the included angle between the second plate portion 1424b′ and the connecting plate portion 1424d′, which will not be described repeatedly. In addition, the ratio value of a length 1424g (shown as a dashed line in the figure) of the connecting plate portion 1424d′ to a thickness 1424h of the first support 14 at the bend may be, but is not limited to, 0.5 to 1.5 in practice.

Furthermore, please refer to FIG. 3, FIG. 4, and FIG. 8; in FIG. 8, the hidden profile of the Z-shaped bending structure 1422a is shown in dashed lines. Although the Z-shaped bending structure 1422a does not directly go through sliding shaft 144b, the Z-shaped bending structure 1422a and the sliding shaft 144b overlap in a direction parallel to the pivot axis A1. This structural configuration is also conducive to the connection stability of the sliding shaft 144b and the corresponding sliding hook 102 of the keycap 10.

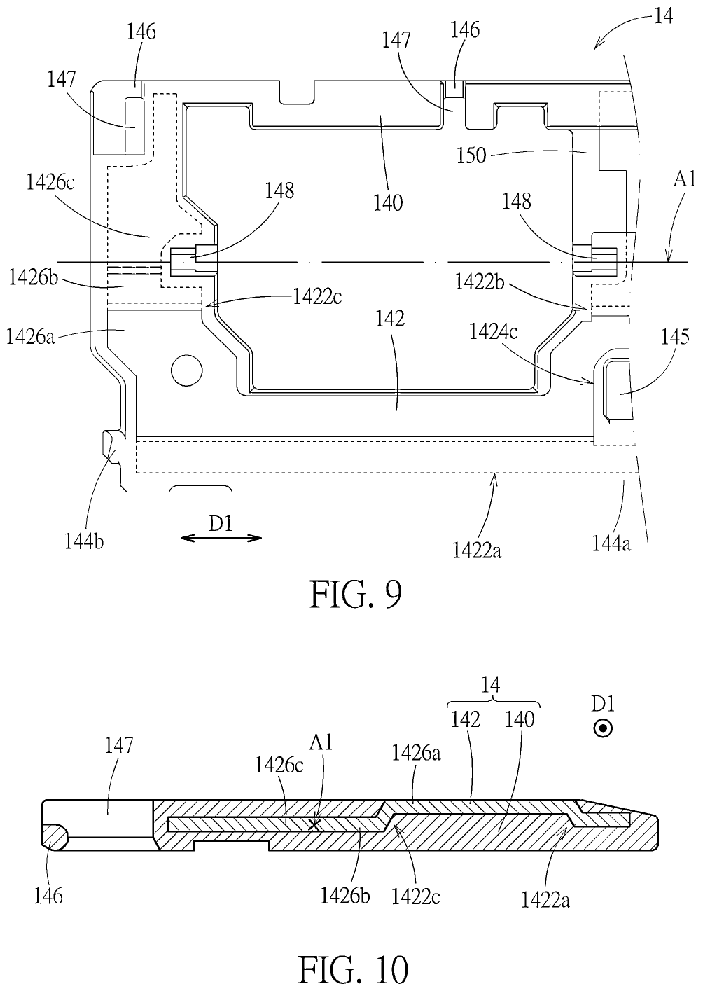

In addition, please refer to FIG. 3, FIG. 4, FIG. 9 and FIG. 10; in FIG. 9, the hidden profile of the first reinforcement part 142 is partially shown in dashed lines. The first support body 140 (or the first support 14) has a plurality of pivot holes 148. The pivot hole 148 may be realized by, but not limited to, a pair of oppositely arranged hooks. However, it is not limited thereto in practice. The first support 14 is pivotally connected with the second support 16 through the plurality of pivot holes 148. As shown by FIG. 9 and FIG. 10, the Z-shaped bending structure 1422c includes a first plate portion 1426a and a second plate portion 1426b. The first plate portion 1426a and the second plate portion 1426b are not coplanar. The first plate portion 1426a is exposed from the first support body 140. The second plate portion 1426b is embedded in the first support body 140. The first reinforcement part 142 has a surrounding portion 1426c at the Z-shaped bending structure 1422c (or logically, it can also be regarded as the surrounding portion 1426c extending from the second plate portion 1426b or formed on the second plate portion 1426b). The surrounding portion 1426c surrounds three sides of the adjacent pivot hole 148 (from the viewpoint of FIG. 9, i.e., the upper side, the left side and the lower side). This structural configuration can increase the structural strength of the pivot hole 148 and improve the stability of the pivot connection between the first support 14 and the second support 16. Furthermore, in the first embodiment, the surrounding portion 1426c is not exposed from the first support body 140. Besides, the surrounding portion 1426c overlaps the pivot hole 148 in a direction parallel to the pivot axis A1, but it is not limited thereto in practice. In addition, bending portions of the Z-shaped bending structure 1422c are adjacent to the pivot hole 148. This structural configuration has the effect of reinforcing the structure of the pivot hole 148. In practice, the position of Z-shaped bending structure 1422c can be modified (as shown by the two chain lines in FIG. 9) so that its bending portions overlap with the pivot hole 148 in a direction parallel to the pivot axis A1 (which also makes the bending portions overlap with a pivot that is inserted into the pivot hole 148), which can further enhance the structural reinforcing effect of the Z-shaped bending structure 1422c on pivot hole 148. At this time, the surrounding portion 1426c is formed on the bending portions of the Z-shaped bending structure 1422c.

As described above, in the first embodiment, the first reinforcement part 142 is partially exposed from the first support body 140. Therein, as shown by FIG. 3, the first support 14 as a whole extends along a reference plane P1 (shown in chain lines; in principle, the reference plane P1 can be regarded as a plane containing the pivot axis A1). The first support body 140 has an upper surface (facing the keycap 10) and a lower surface (facing the base plate 12) in a direction perpendicular to the reference plane P1. The first reinforcement part 142 is exposed from the upper surface and not exposed from the lower surface. This structural configuration can effectively prevent the first reinforcement part 142 from directly colliding with the underlying components (such as the base plate 12) to cause sound (for example, the first reinforcement part 142 and the base plate 12 are both made of metal). However, it is not limited thereto in practice. In addition, the description about the bending angle of the Z-shaped bending structure 1422a is also applicable here if there is no contradiction with the Z-shaped bending structure 1422b˜d, which will not be repeated in addition.

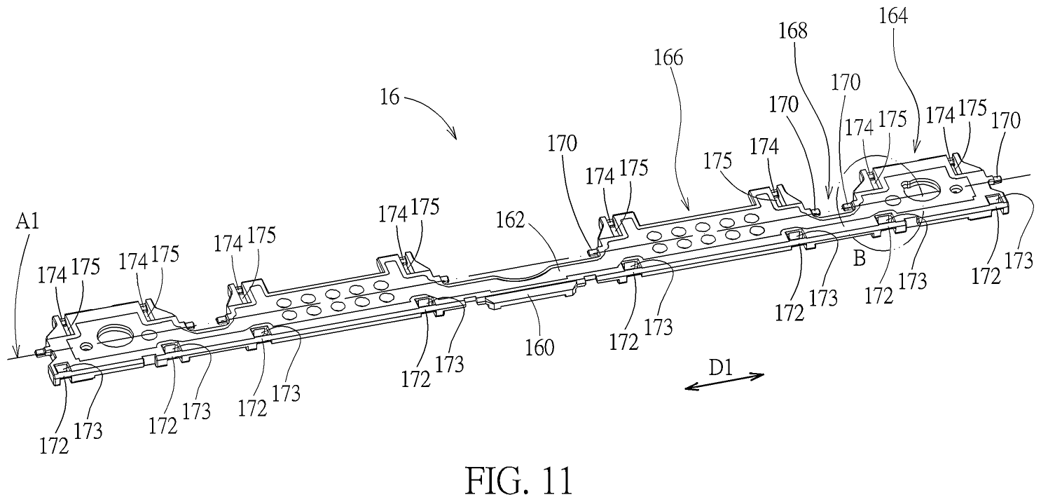

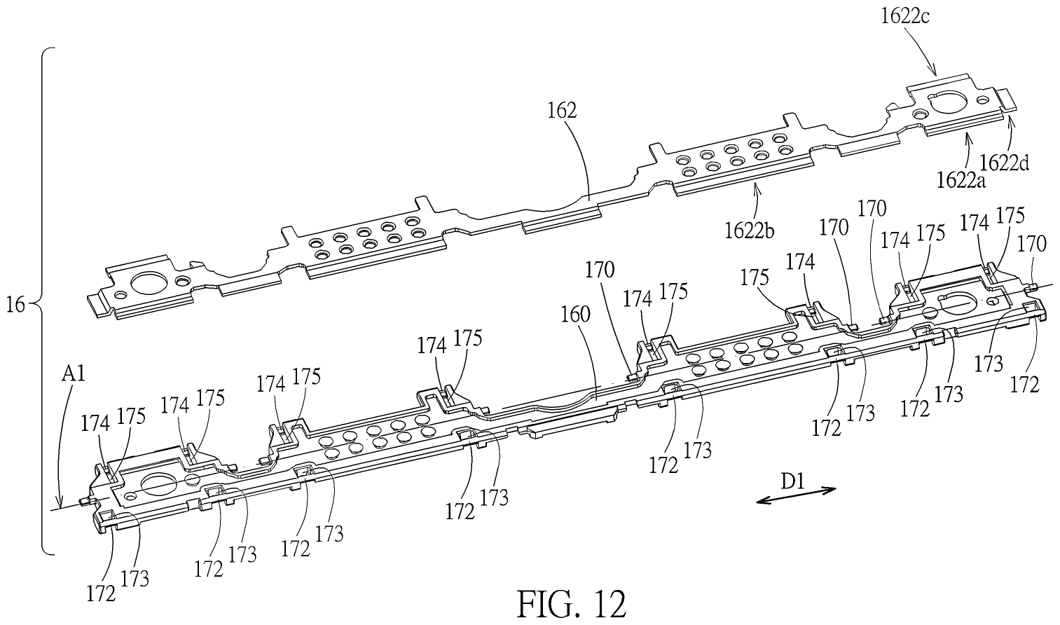

Please refer to FIG. 11 and FIG. 12. The second support 16 includes a second support body 160 and a second reinforcement part 162. The second reinforcement part 162 is embedded into the second support body 160. An elastic modulus of the second reinforcement part 162 is greater than an elastic modulus of the second support body 160. Similarly, the second reinforcement part 162 also has the effect of reinforcing the structure of the second support 16. The second support 16 as a whole includes a plurality of supporting portions and a plurality of bridge connecting portions (of which the ranges are indicated by boxes in chain lines in FIG. 11). The plurality of supporting portions and the plurality of bridge connecting portions are staggered along the pivot axis A1. The bridge connecting portion connects adjacent supporting portions. The second reinforcement part 162 is present in the supporting portions and the bridge connecting portions. Each supporting portion has a pivot on both sides along the pivot axis A1. The second support 16 is pivotally connected to the first support 14 through the pivots (inserted into the pivot holes 148). In the first embodiment, the second support 16 is pivotally connected to the inside of the first support 14; in other words, the second support 16 is located inside the rectangular outer frame portion of the first support 14 (also see FIG. 1 and FIG. 2). Therein, the supporting portion is located between two adjacent intermediate connecting portions, or between a short side of the rectangular outer frame portion and an adjacent intermediate connecting portion; on the other hand, the first support 14 is located on opposite outer sides of the second support 16 on the pivot axis A1. In logic, the first support 14 can be regarded as an outer support, and the second support 16 can be regarded as an inner support.

Furthermore, to simplify the explanation, two of the supporting parts and the bridge connecting portion between them are taken as an example, such as a first portion 164, a second portion 166, and a bridge connecting portion 168 (connecting the first portion 164 and the second portion 166) in the figures. Pivots 170 are provided on the first portion 164 and the second portion 166. The second support 16 is pivotally connected to the first support 14 by inserting the pivots 170 into the pivot holes 148 (of the first support 14). The second reinforcement part 162 extends in the first portion 164, the second portion 166, and the bridge connecting portion 168. The second reinforcement part 162 includes a plurality of Z-shaped bending structures 1622a˜d. Therein, the Z-shaped bending structures 1622a˜c extend parallel to the pivot axis A1 (or in other words, the Z-shaped bending structure 1622a˜c extend parallel to the pivot axis A1 with a Z-shaped cross-section). The Z-shaped bending structure 1622d extends in a direction perpendicular to the pivot axis A1 and overlaps the pivot 170 in a direction parallel to the pivot axis A1. The Z-shaped bending structure 1622d can enhance the ability of the reinforcement part 162 here to resist deflection along a direction perpendicular to the pivot axis A1, which helps the second support 16 to stably transmit force in this direction (perpendicular to the pivot axis A1). Furthermore, the bridge connecting portion 168 spans the corresponding intermediate connecting portion of the rectangular outer frame portion of the first support 14 (also see FIG. 1 and FIG. 2). Therein, the intermediate connecting portion has a recess 150 (see FIG. 3). The recess 150 is located below the bridge connecting portion 168. The first reinforcement part 142 is exposed from the recess 150. When the first supper 14 and the second support 16 are stacked together, the bridge connecting portion 168 enters the recess 150. Furthermore, as shown by FIG. 1, FIG. 2, and FIG. 11, the second support body 160 (or the second support 16) has a plurality of holder shafts 172 and a plurality of base shafts 174, which are located on the plurality of supporting portions, in logic. A holder hole 173 is formed beside the holder shaft 172. A base hole 175 is formed beside the base shaft 174. The second support 16 is rotatably connected to the keycap 10 (or the holder hooks 104 thereof) through the holder shafts 172. The holder hooks 104 extend into the holder holes 173 correspondingly. The second support 16 is rotatably connected to the base plate 12 (or the base hooks 124 thereof) through the base shafts 174; therein, the base shaft 174 is rotatably hooked by the corresponding base hook 124, and the base hook 124 extends in to the corresponding base hole 175. In addition, the bridge connecting portion 168 is located on the side of the second support 16 used to be connected to the keycap 10. This structural configuration helps to improve the stability of the second support 16 supporting the keycap 10.

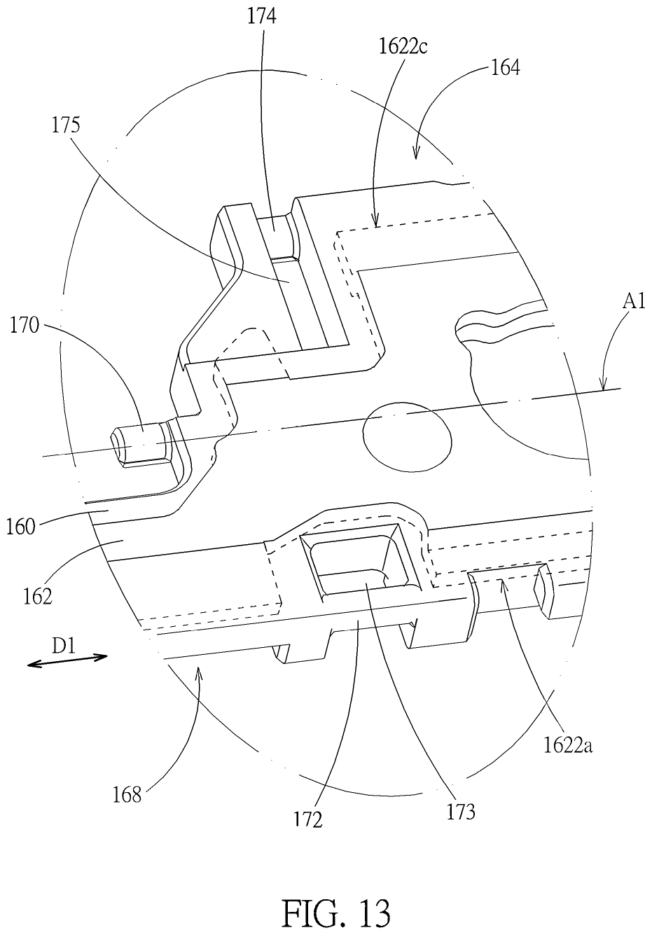

Please refer to FIG. 11 to FIG. 13; in FIG. 13, the hidden profile of the second reinforcement part 162 is partially shown in dashed lines. The second reinforcement part 162 surrounds three sides of the holder hole 173 and does not extend into the holder shaft 172. This structural configuration helps to enhance the structural strength of the second support 16 here (that is, to strengthen the structure of the holder hole 173, which is conducive to the structural stability of the holder shaft 172), and is conducive to the stability of the connection between the holder shaft 172 and the keycap 10 at the holder hook 104. However, it is not limited thereto in practice. For example, if the structural size design allows, the second reinforcement part 162 can also be designed to go through the holder shaft 172, which can further enhance the structural strength of the second support 16 at the holder hole 173 and the holder shaft 172, and also enhance the stability of the linkage between the second support 16 and the keycap 10. Furthermore, the second reinforcement part 162 is located on three sides of the base hole 175 (i.e., the left base hole 175 in FIG. 13) of the first portion 164, thereby reinforcing the structure of the base hole 175. In addition, the second reinforcement part 162 is also partially exposed from the second support body 160; therein, the second reinforcement part 162 is exposed from the upper surface of the second support body 160 (facing the keycap 10) and not exposed from the lower surface of the second support 160 (facing the base plate 12). This structural configuration can also effectively prevent the second reinforcement part 162 from directly colliding with the underlying components (such as the base plate 12) to cause sound (for example, the second reinforcement part 162 and the base plate 12 are both made of metal).

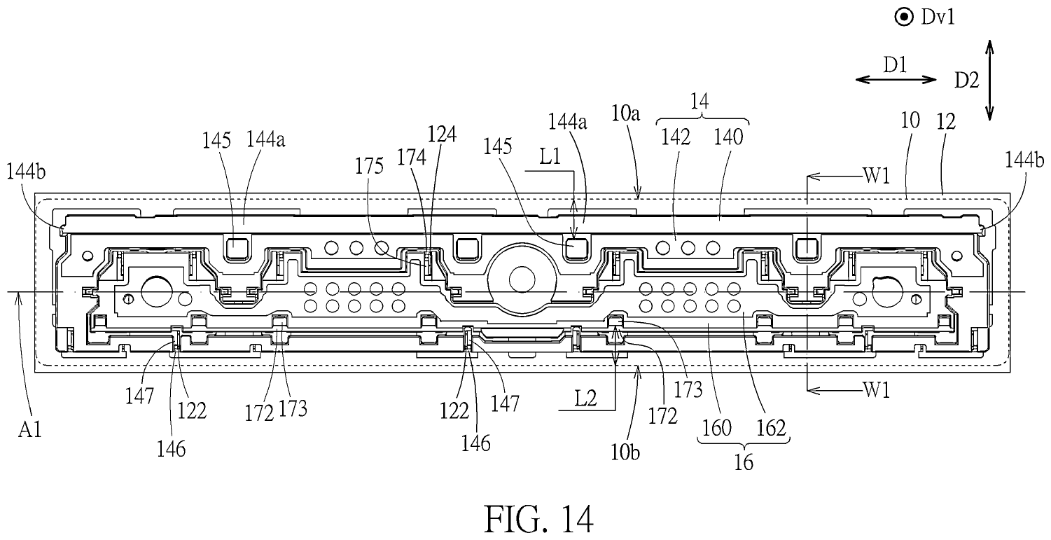

In addition, please refer to FIG. 3, FIG. 11 and FIG. 14; in FIG. 14, the profile of the keycap 10 is shown in dashed lines. In the first embodiment, a shaft diameter of the sliding shaft 144a (or the sliding shaft 144b) of the first support 14 is greater than a shaft diameter of the holder shaft 172 of the second support 16, which helps to enhance the stability of the rotation and sliding of the sliding shaft 144a (or the sliding shaft 144b). Furthermore, the keycap 10 has a first long side edge 10a and a second long side edge 10b. The first long side edge 10a and the second long side edge 10b both are parallel to the long side direction D1. In FIG. 14, the vertical direction Dv1 is perpendicular to the paper, so the structural profiles presented in the figure are equivalent to their vertical projections on the paper. In the first embodiment, there is a first distance L1 in the short side direction D2 between a projection of the sliding hole 145 of the first support 14 in the vertical direction Dv1 and a projection of the first long side edge 10a of the keycap 10 in the vertical direction Dv1. There is a second distance L2 in the short side direction D2 between a projection of the holder hole 173 of the second support 16 in the vertical direction Dv1 and a projection of the second long side edge 10b of the keycap 10 in the vertical direction Dv1. The first distance L1 is greater than the second distance L2. This structural configuration provides a larger space for the design of the structural and movement of the sliding shafts 144a of the first support 14.

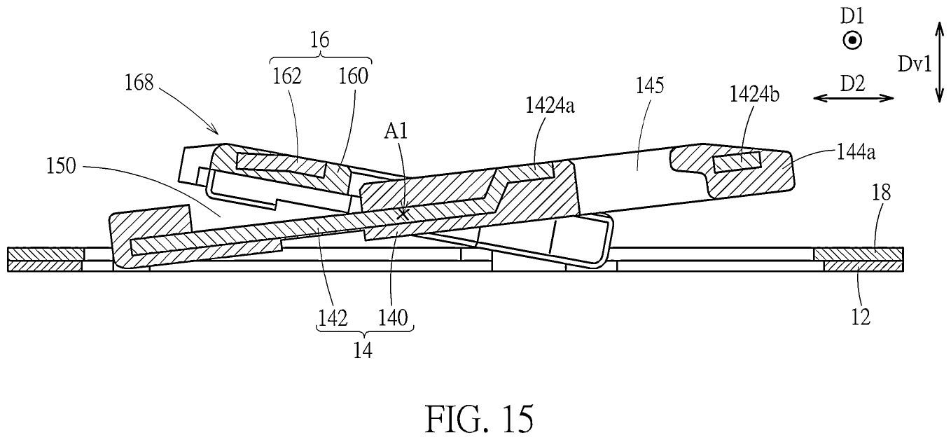

Furthermore, please refer to FIG. 3, FIG. 4, FIG. 11, FIG. 12 and FIG. 15; in FIG. 15, the keycap 10 is not shown to simplify the drawing. The first reinforcement part 142 and the second reinforcement part 162 overlap in the vertical direction Dv1. As shown by FIG. 15, a portion of the second support body 160 corresponding to the bridge connecting portion 168 separates the first reinforcement part 142 and the second reinforcement part 162 in the vertical direction Dv1, so that even if the first reinforcement part 142 is exposed from the recess 150, the second reinforcement part 162 can still be prevented from hitting the first reinforcement part 142 to cause sound.

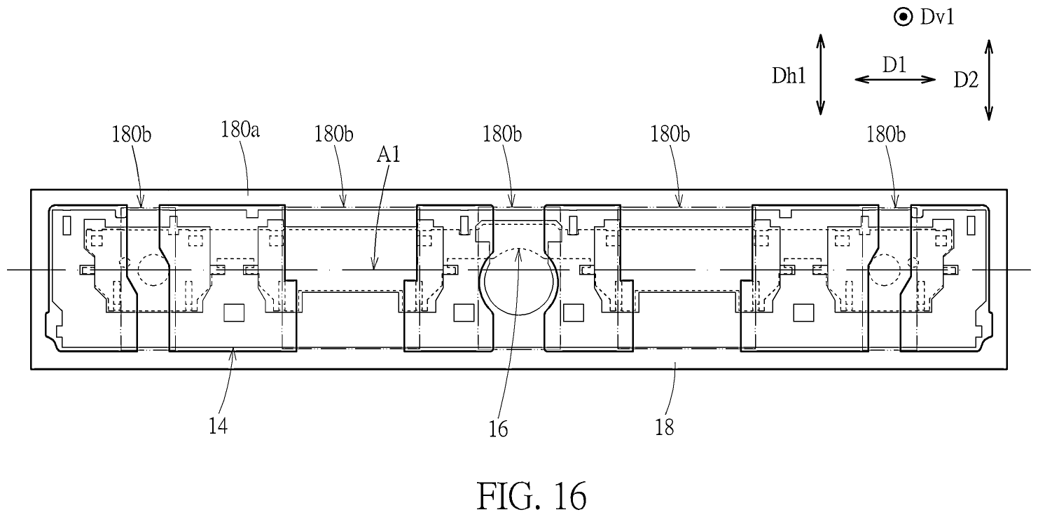

Please refer to FIG. 16, which is a top view of the switch circuit board 18; therein, the profile of the first support 14 is shown in thin lines, and the profile of the second support 16 is shown in dashed lines. The switch circuit board 18 includes a peripheral portion 180a and a plurality of circuit connecting portions 180b (of which the ranges are indicated by boxes in chain lines; the other portions of the switch circuit board 18 are the peripheral portion 180a). The circuit connecting portion 180b extends along a horizontal direction Dh1 (indicated by a double-headed arrow in the figure; that is, the length direction of the circuit connecting portion 180b is parallel to the horizontal direction Dh1) and connects opposite sides of the peripheral portion 180a. The horizontal direction Dh1 is perpendicular to the vertical direction Dv1 and the pivot axis A1; thus, the horizontal direction Dh1 is parallel to the short side direction D2. The switch circuit board 18 does not have a portion extending parallel to the pivot axis A1 inside the peripheral portion 180a. Compared with a switch circuit board (the inside of which usually contains vertical and horizontal connection structures) of a common keyswitch structure, there are only connection structures (i.e., circuit connecting portions 180b) extending in the same direction inside the switch circuit board 18, which reduces the degree of interference with the first support 14 and second support 16 structures. In the first embodiment, the ratio value of length to width of the keyswitch structure 1 is about 6. The keyswitch structure 1 uses five circuit connecting portions 180b extending roughly parallel to the short side direction D2; however, it is not limited thereto in practice. Furthermore, the first support 14 and the second support 16 are located inside the peripheral portion 180a in the vertical direction Dv1; in other words, the first support 14 and the second support 16 do not overlap the peripheral portion 180a in the vertical direction Dv1. The circuit connecting portion 180b does not overlap some of the intermediate connecting portions of the first support 14 (e.g., the outermost intermediate connecting portion along the pivot axis A1) in the vertical direction Dv1, so that the structure of these intermediate connecting portions can be stretched downward to increase structural strength, which also increases the structural design flexibility of the reinforcement parts (such as the first reinforcement part 142) here.

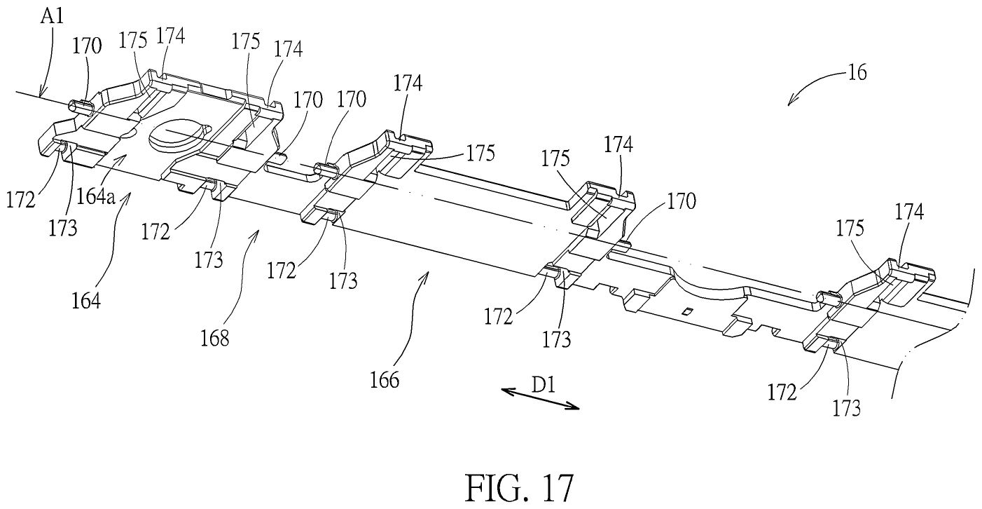

In addition, in the first embodiment, the supporting portions of the second support 16 overlap the circuit connecting portions 180b of the switch circuit board 18 in the vertical direction Dv1. Taking the first portion 164 of the second support 16 as an example, (please also refer to FIG. 17) the first portion 164 has a recess 164a. When the first support 14 and the second support 16 are stacked together, the corresponding circuit connecting portion 180b enters the recess 164a. On the other hand, through the design of the recess 164a, the first portion 164 can extend downward to increase its structural strength, which also increases the structural design flexibility of the reinforcement parts (such as the second reinforcement part 162) here. Thereby, this structural configuration can improve the structural strength of the first portion 164 and help to reduce the overall height of the keyswitch structure 1. The same goes for the second portion 166 and will not be repeatedly described. In addition, in the first embodiment, the rectangular outer frame portion of the first support 14 also overlaps the circuit connecting portion 180b of the switch circuit board 18 in the vertical direction Dv1. The rectangular outer frame portion has a recess correspondingly (e.g., the recess 152 shown in FIG. 3 and FIG. 4), so that when the first support 14 and the second support 16 are stacked together, the corresponding circuit connecting portion 180b also enters the recess 152. Similarly, this structural configuration can improve the structural strength of the rectangular outer frame portion of the first support 14 and help to reduce the overall height of the keyswitch structure 1.

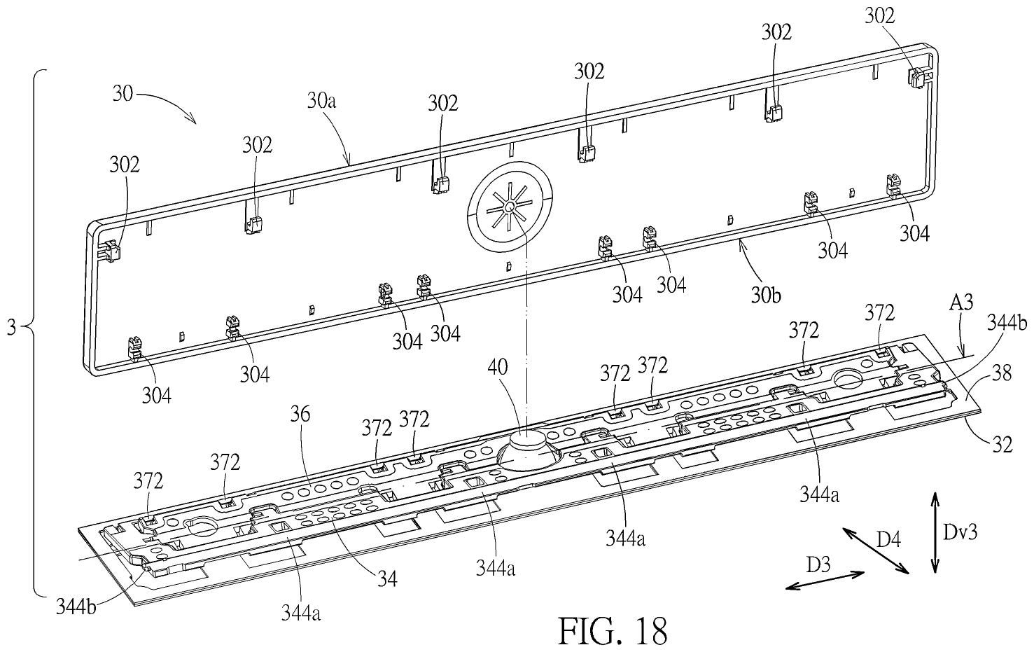

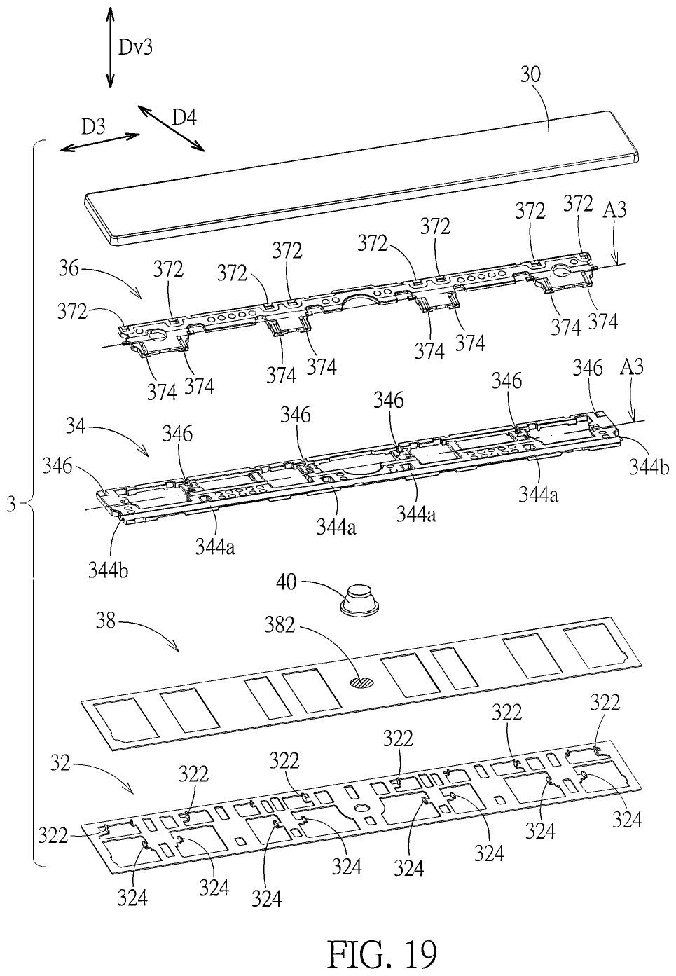

Please refer to FIG. 18 and FIG. 19. A keyswitch structure 3 according to a second embodiment is a long rectangular keyswitch structure, which has a long side direction D3 and a short side direction D4 (both are indicated by double-headed arrows in the figures). The long side direction D3 is perpendicular to the short side direction D4. In practice, the keyswitch structure 3 can be but is not limited to a space key. The keyswitch structure 3 includes a keycap 30, a base plate 32, a first support 34, a second support 36, a switch circuit board 38, and an elastic dome 40. The keycap 30 is disposed above the base plate 32. The first support 34 and the second support 36 are pivotally connected around a pivot axis A3 (indicated by a chain line). The pivot axis A3 is parallel to the long side direction D3. The first support 34 and the second support 36 are connected to the keycap 30 and the base plate 32 to support the keycap 30 above the base plate 32, so that the keycap 30 can move (e.g. moving up and down or parallel to a vertical direction Dv3) relative to the base plate 32 through the first support 34 and the second support 36. The vertical direction Dv3 (indicated by a double-headed arrow in the figures) is perpendicular to the long side direction D3 and the short side direction D4. The switch circuit board 38 is placed on the base plate 32. The switch circuit board 38 can be but not limited to a membrane circuit board, and has a switch 382 (shown as a circle filled with oblique lines in the figure), roughly corresponding to the center of the keycap 30. The elastic dome 40 corresponds to the switch 382 and is disposed on switch circuit board 38 and below the keycap 30. The keycap 30 can be pressed to move toward the base plate 32, and then squeezes the elastic dome 40 to trigger the switch 382 downward. Therefore, in logic, the combination of the first support 34 and the second support 36 or the combination of the first support 34, the second support 36, and the base plate 32 can be regarded as a keycap lifting mechanism.

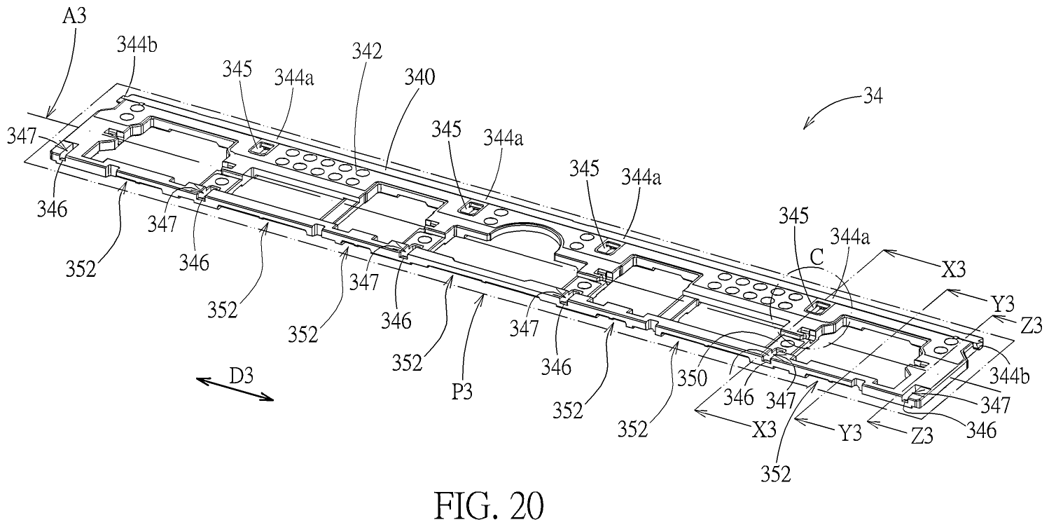

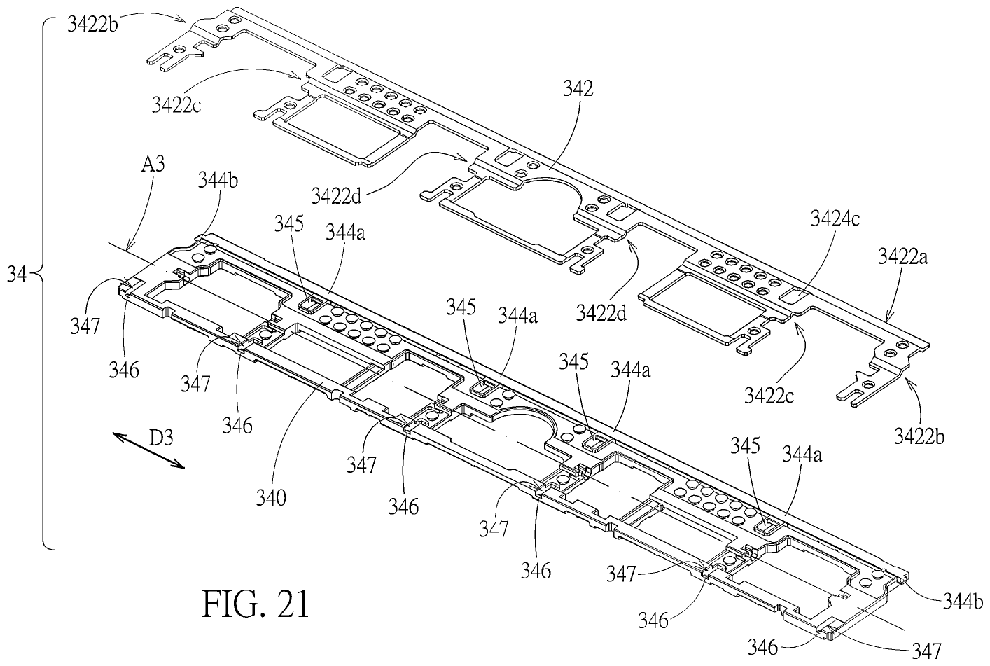

For further details, please refer to FIG. 20 and FIG. 21. The first support 34 includes a first support body 340 and a first reinforcement part 342. The first reinforcement part 342 is embedded into the first support body 340. An elastic modulus of the first reinforcement part 342 is greater than an elastic modulus of the first support body 340. Thereby, the first reinforcement part 342 has the effect of reinforcing the structure of the first support 34. Furthermore, in the first embodiment, the first support 34 as a whole show a frame structure, and mainly includes a rectangular outer frame portion and a plurality intermediate connecting portions which connect two long sides (parallel to the long side direction D3) of the rectangular outer frame portion inside the rectangular outer frame portion. The first support 34 is connected to the keycap 30 through one of the long sides, and is connected to the base plate 32 through the other long side. The first reinforcement part 342 as a whole includes a long arm and a plurality of support arms protruding from the long arm perpendicular to the long arm. The ends of two support arms are connected with a connecting arm to form an annular structure. The long arm is located in one of the long sides of the rectangular outer frame portion (i.e., the long side that is connected to the keycap 30) and extends parallel to the pivot axis A3. The plurality of support arms extend in the plurality of intermediate connecting portions and two short sides of the outer frame portion; the plurality of support arms all extend to the other long side of the rectangular outer frame portion, and the above connecting arms extend in this long side. Therein, the plurality of support arms can improve the structural strength of the intermediate connecting portions and is also conducive to the structural strength of the long side connected to the base plate 32. The plurality of connecting arms can improve the structural strength of the long side connected to the base plate 32. This annular structure can improve the structural reinforcing effect of the first reinforcement part 342 on the first support body 340. The first reinforcement part 342 includes a plurality of Z-shaped bending structures 3422a˜d, which all extend parallel to the pivot axis A3 (or in other words, the Z-shaped bending structures 3422a˜d extend parallel to the pivot axis A3 with a Z-shaped cross-section), thereby increasing the ability of the first reinforcement part 342 to resist deflection along the pivot axis A3, and also enhancing the linkage of the keycap lifting mechanism (including the mutually pivoted first support 34 and second support 36) in the long side direction D3 (or in other words, increasing the efficiency of transmitting force in the long side direction D3). Therein, the Z-shaped bending structure 3422a is located on the long arm, and the Z-shaped bending structures 3422b˜d are located on the plurality of support arms (in which the Z-shaped bending structure 3422c can logically be regarded as being located at the connection between the support arm and the long arm). The Z-shaped bending structures 3422a-d all can further enhance the structural reinforcing effect of the first reinforcement part 342 on the first support body 340.

Furthermore, as shown by FIG. 18 and FIG. 20, the first support body 340 (or the first support 34) has a plurality of sliding shafts 344a and 344b (on the long side of the outer frame portion that is connected to the keycap 30) and a plurality of base shafts 346 (on the long side of the outer frame portion that is connected to the base plate 32). A sliding hole 345 is formed beside the sliding shaft 344a. A base hole 347 is formed beside the base shaft 346. The first support 34 is slidably and rotatably connected to the keycap 30 (or sliding hooks 302 thereof) through the sliding shafts 344a and 344b, and the sliding hooks 302 extend into the sliding holes 345 correspondingly. The first support 34 is rotatably connected to the base plate 32 (or base hooks 322 thereof) through the base shafts 346; therein, the base shafts 346 are rotatably hooked by the base hooks 322 correspondingly, and the base hooks 322 extend into the base holes 347 correspondingly.

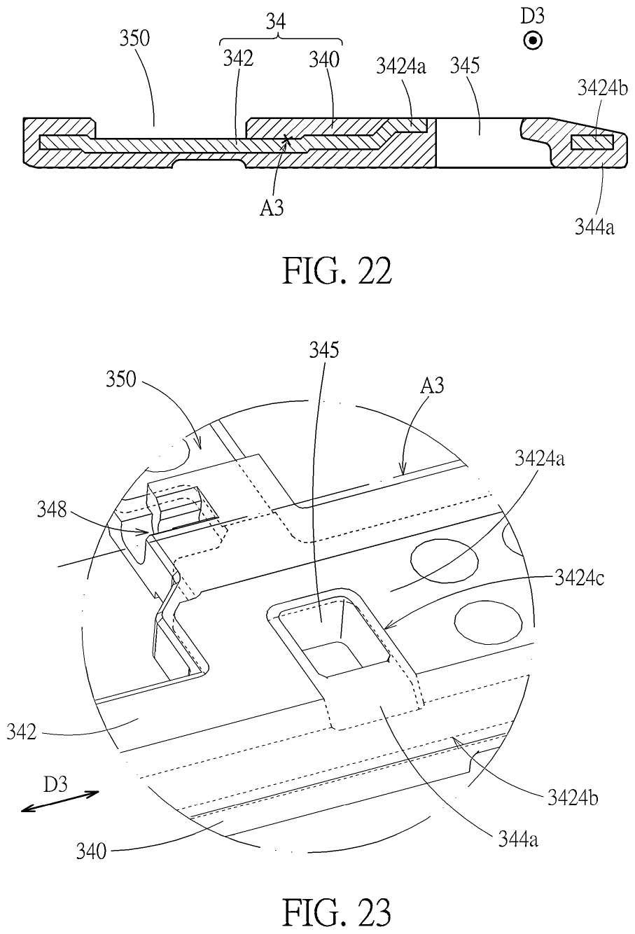

Please refer to FIG. 20 to FIG. 23; in FIG. 23, the hidden profile of the first reinforcement part 342 is partially shown in dashed lines. The first reinforcement part 342 surrounds the sliding hole 345 and goes through the sliding shaft 344a, thereby enhancing the structural strength of the first support 34 at the sliding hole 345 and the sliding shaft 344a, and also improving the stability of the mutual linkage between the first support 34 and the keycap 30. In the second embodiment, the first reinforcement part 342 uses the Z-shaped bending structure 3422a to achieve the above structural configuration, but it is not limited to thereto in practice. Therein, the Z-shaped bending structure 3422a is located on a side fringe of the first reinforcement part 342 and is distributed throughout the side fringe. The Z-shaped bending structure 3422a includes a first plate portion 3424a and a second plate portion 3424b at the circle C in FIG. 20. The first plate portion 3424a and the second plate portion 3424b are not coplanar. The first plate portion 3424a and the second plate portion 3424b are connected to form a through hole 3424c. The sliding hole 345 is located inside the through hole 3424c. The second plate portion 3424b goes through the sliding shaft 344a. Furthermore, as shown by FIG. 22, the sliding shaft 344a extends parallel to pivot axis A3 with a non-rectangular cross-section. In the second embodiment, the non-rectangular cross-section is roughly trapezoidal, so that the thickness of the sliding shaft 344a gradually decreases in the direction away from pivot axis A3, which can effectively reduce the degree of the structural interference between the sliding shaft 344a and the keycap 30. That the second plate portion 3424b goes through the sliding shaft 344a can compensate for the reduction in the structural strength of the sliding shaft 344a caused by the gradual decrease in thickness, and can even further enhance the structural strength of the sliding shaft 344a.

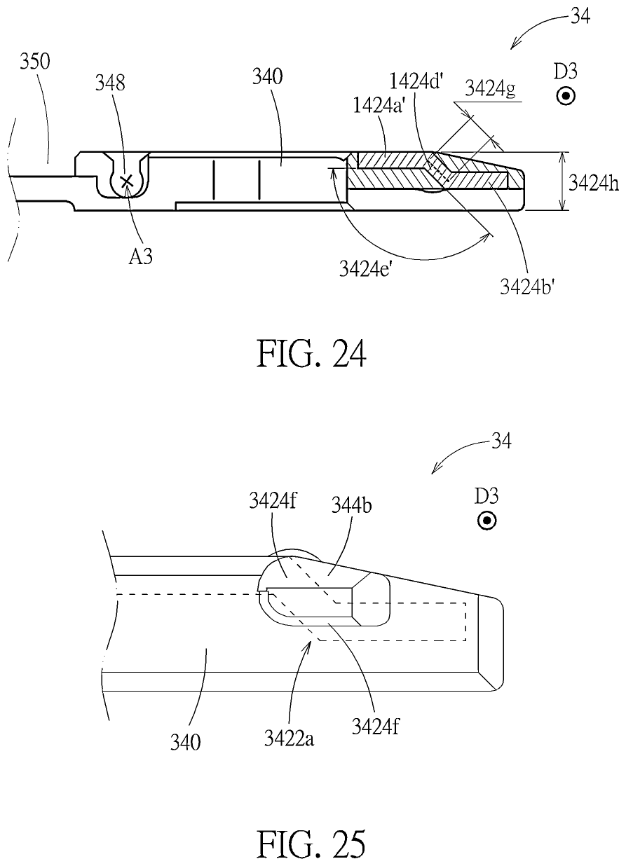

On the other hand, the first support body 340 has a side fringe (i.e., the long side that is connected to the keycap 30), of which the thickness gradually decreases in the direction away from the pivot axis A3, which can effectively reduce the degree of the structural interference between the first support body 340 and the keycap 30. The Z-shaped bending structure 3422a can extend perpendicular to the pivot axis A3 into the side fringe through its structural bending characteristics, which can compensate for the reduction in the structural strength of the side fringe due to the gradual decrease in thickness, and can even further enhance the structural strength of the side fringe. Furthermore, take the first support 34 at the line Y3-Y3 in FIG. 20 as an example. As shown by FIG. 24, the Z-shaped bending structure 3422a includes a first plate portion 3424a′, a second plate portion 3424b′, and a connecting plate portion 3424d′. The first plate portion 3424a′, the second plate portion 3424b′, and the connecting plate portion 3424d′ extend parallel to the pivot axis A3 and are not coplanar. The first plate portion 3424a′ and the second plate portion 3424b′ are connected to opposite sides of the connecting plate portion 3424d′. The first plate portion 3424a′ is exposed from the first support body 340. The second plate portion 3424b′ extends in the side fringe. Furthermore, in the second embodiment, an included angle 3424e′ is formed by the first plate portion 3424a′ and the connecting plate portion 3424d′ (i.e. a bending angle). The included angle 3424e′ is greater than 90 degrees, e.g., 120 degrees. However, it is not limited thereto in practice. For example, the included angle 3424e′ is between 40 degrees and 90 degrees. This description about the bending angle also applies to the included angle between the second plate portion 3424b′ and the connecting plate portion 3424d′, which will not be described repeatedly. In addition, the ratio value of a length 3424g (shown as a dashed line in the figure) of the connecting plate portion 3424d′ to a thickness 3424h of the first support 34 at the bend may be, but is not limited to, 0.5 to 1.5 in practice.

Furthermore, please refer to FIG. 20, FIG. 21, and FIG. 25; in FIG. 25, the hidden profile of the Z-shaped bending structure 3422a is shown in dashed lines. Although the Z-shaped bending structure 3422a does not directly go through the sliding shaft 344b, the Z-shaped bending structure 3422a and the sliding shaft 344b overlap in a direction parallel to the pivot axis A3. This structural configuration is also conducive to the connection stability of the sliding shaft 344b and the corresponding sliding hook 302 of the keycap 30. Furthermore, as shown by FIG. 25, in the second embodiment, two bending portions 3424f of the Z-shaped bending structure 3422a both overlap the sliding shaft 344b in a direction parallel to the pivot axis A3, which is conducive to the stability of the connection of the sliding shafts 344b with the sliding hooks 302 of the keycap 30.

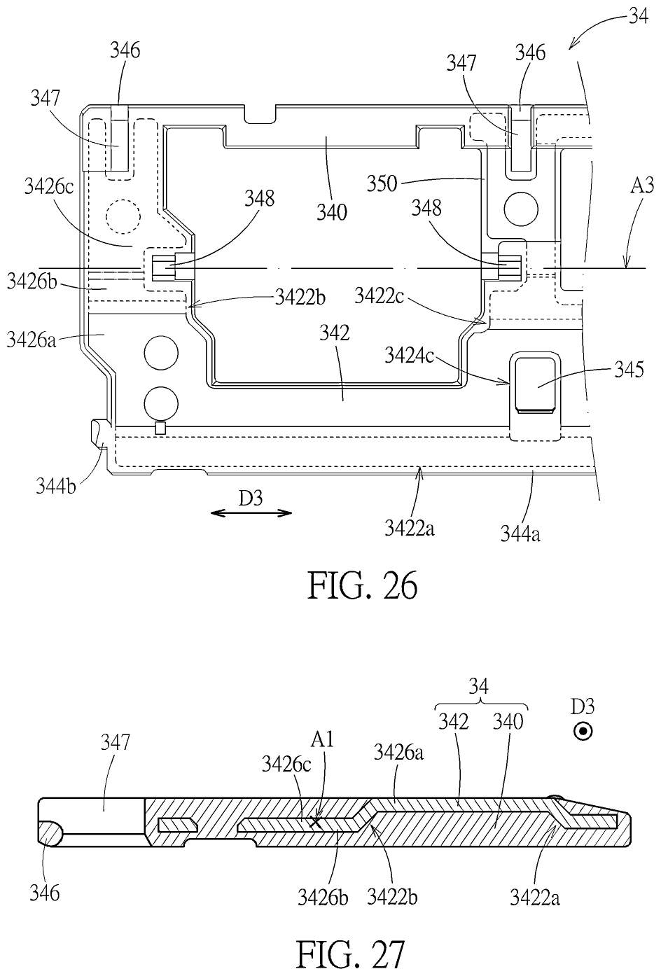

In addition, please refer to FIG. 20, FIG. 21, FIG. 26 and FIG. 27; in FIG. 26, the hidden profile of the first reinforcement part 342 is partially shown in dashed lines. The first support body 340 (or the first support 34) has a plurality of pivot holes 348. The pivot hole 348 may be realized by, but not limited to, a pair of oppositely arranged hooks. However, it is not limited thereto in practice. The first support 34 is pivotally connected with the second support 36 through the plurality of pivot holes 348. As shown by FIG. 26 and FIG. 27, the Z-shaped bending structure 3422b includes a first plate portion 3426a and a second plate portion 3426b. The first plate portion 3426a and the second plate portion 3426b are not coplanar. The first plate portion 3426a is exposed from the first support body 340. The second plate portion 3426b is embedded in the first support body 340. The first reinforcement part 342 has a surrounding portion 3426c at the Z-shaped bending structure 3422b (or logically, it can also be regarded as the surrounding portion 3426c extending from the second plate portion 3426b or formed on the second plate portion 3426b). The surrounding portion 3426c surrounds three sides of the adjacent pivot hole 348 (from the viewpoint of FIG. 26, i.e., the upper side, the left side and the lower side). This structural configuration can increase the structural strength of the pivot hole 348 and improve the stability of the pivot connection between the first support 34 and the second support 36. Furthermore, in the second embodiment, the surrounding portion 3426c is not exposed from the first support body 340. Besides, the surrounding portion 3426c overlaps the pivot hole 348 in a direction parallel to the pivot axis A3, but it is not limited thereto in practice. In addition, bending portions of the Z-shaped bending structure 3422b are adjacent to the pivot hole 348. This structural configuration has the effect of reinforcing the structure of the pivot hole 348. In practice, the position of Z-shaped bending structure 3422b can be modified (as shown by the two chain lines in FIG. 26) so that its bending portions overlap with the pivot hole 348 in a direction parallel to the pivot axis A3 (which also makes the bending portions overlap with a pivot that is inserted into the pivot hole 348), which can further enhance the structural reinforcing effect of the Z-shaped bending structure 3422b on pivot hole 348. At this time, the surrounding portion 3426c is formed on the bending portions of the Z-shaped bending structure 3422b. In addition, as shown by FIG. 26, the first reinforcement part 342 also surrounds three sides of another pivot hole 348 at Z-shaped bending structure 3422c to strengthen the structure of this pivot hole 348.

In addition, as shown by FIG. 26, ends of the support arms of the first reinforcement part 342 corresponding to the base shafts 346 and the base holes 347 also surround three sides of the base holes 347, which reinforces the structure of the base holes 347 and improves the stability of the mutual interaction between the first support 34 and the base plate 32. Furthermore, in practice, if the structural size design allows, the first reinforcement part 342 can also be designed to go through the base shaft 346, which can further enhance the structural strength of the first support 34 at the base shaft 346 and the base hole 347.

As described above, in the first embodiment, the first reinforcement part 342 is partially exposed from the first support body 340. Therein, as shown by FIG. 20, the first support 34 as a whole extends along a reference plane P3 (shown in chain lines; in principle, the reference plane P3 can be regarded as a plane containing the pivot axis A3). The first support body 340 has an upper surface (facing the keycap 30) and a lower surface (facing the base plate 32) in a direction perpendicular to the reference plane P3. The first reinforcement part 342 is exposed from the upper surface and not exposed from the lower surface. This structural configuration can effectively prevent the first reinforcement part 342 from directly colliding with the underlying components (such as the base plate 32) to cause sound (for example, the first reinforcement part 342 and the base plate 32 are both made of metal). However, it is not limited thereto in practice. In addition, the description about the bending angle of the Z-shaped bending structure 3422a is also applicable here if there is no contradiction with the Z-shaped bending structure 3422b˜d, which will not be repeated in addition.

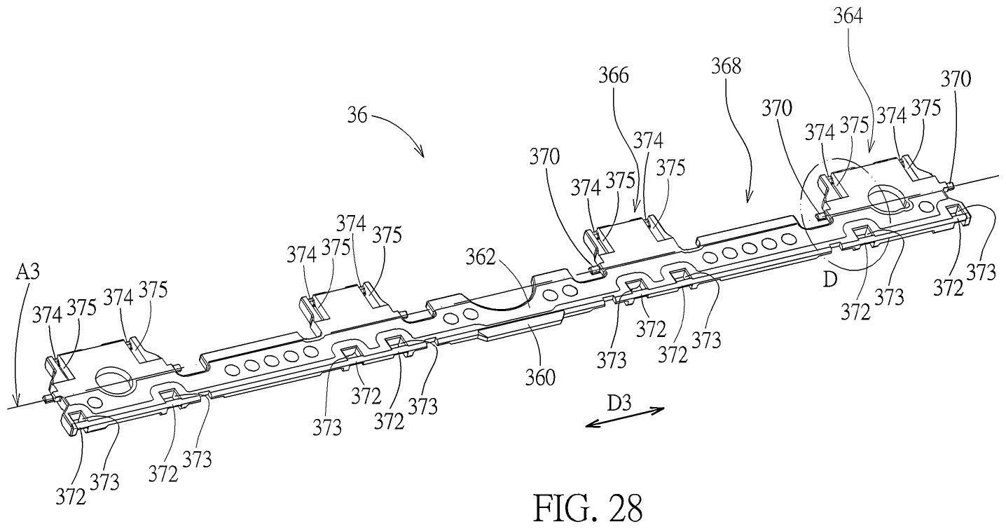

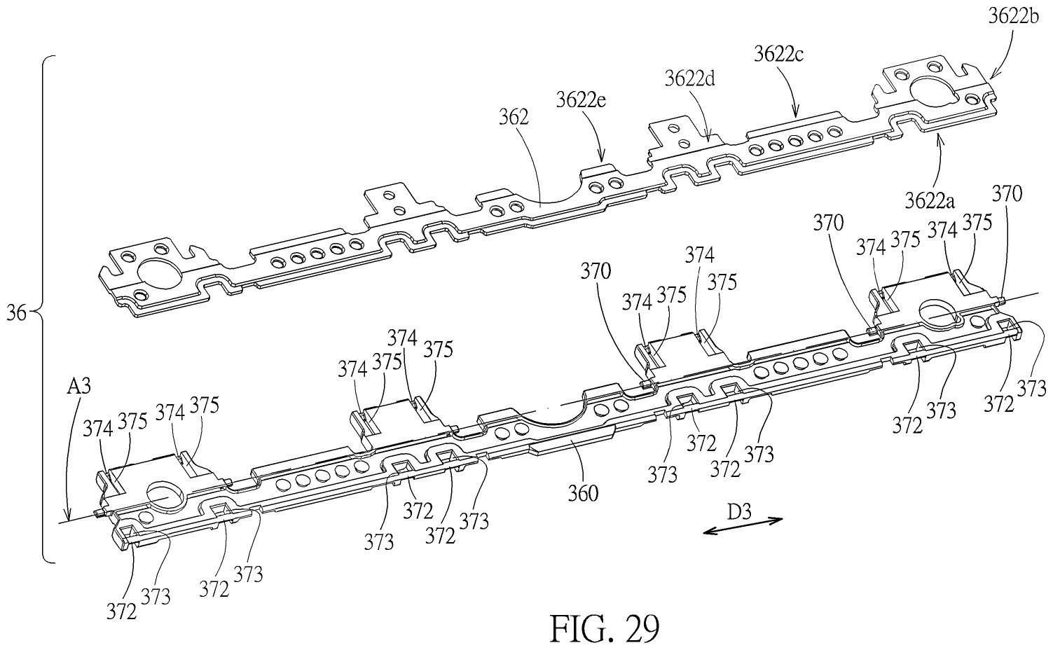

Please refer to FIG. 28 and FIG. 29. The second support 36 includes a second support body 360 and a second reinforcement part 362. The second reinforcement part 362 is embedded into the second support body 360. An elastic modulus of the second reinforcement part 362 is greater than an elastic modulus of the second support body 360. Similarly, the second reinforcement part 362 also has the effect of reinforcing the structure of the second support 36. The second support 36 as a whole includes a plurality of supporting portions and a plurality of bridge connecting portions (of which the ranges are indicated by boxes in chain lines in FIG. 28). The plurality of supporting portions and the plurality of bridge connecting portions are staggered along the pivot axis A3. The bridge connecting portion connects adjacent supporting portions. The second reinforcement part 362 is present in the supporting portions and the bridge connecting portions. Each supporting portion has a pivot on both sides along the pivot axis A3. The second support 36 is pivotally connected to the first support 34 through the pivots (inserted into the pivot holes 348). In the second embodiment, the second support 36 is pivotally connected to the inside of the first support 34; in other words, the second support 36 is located inside the rectangular outer frame portion of the first support 34 (also see FIG. 18 and FIG. 19). Therein, the supporting portion is located between two adjacent intermediate connecting portions, or between a short side of the rectangular outer frame portion and an adjacent intermediate connecting portion; on the other hand, the first support 34 is located on opposite outer sides of the second support 36 on the pivot axis A3. In logic, the first support 34 can be regarded as an outer support, and the second support 36 can be regarded as an inner support.

Furthermore, to simplify the explanation, two of the supporting parts and the bridge connecting portion between them are taken as an example, such as a first portion 364, a second portion 366, and a bridge connecting portion 368 (connecting the first portion 364 and the second portion 366) in the figures. Pivots 370 are provided on the first portion 364 and the second portion 366. The second support 36 is pivotally connected to the first support 34 by inserting the pivots 370 into the pivot holes 348 (of the first support 34). The second reinforcement part 362 extends in the first portion 364, the second portion 366, and the bridge connecting portion 368. The second reinforcement part 362 includes a plurality of Z-shaped bending structures 3622a˜e. Therein, the Z-shaped bending structures 3622a extends along an edge (close to the keycap 30) of the second reinforcement part 362 (including a component extending parallel to the pivot axis A3 and a component extending perpendicular to the pivot axis A3). The Z-shaped bending structures 3622b˜e extend parallel to the pivot axis A3 (or in other words, the Z-shaped bending structures 3622b˜e extend parallel to the pivot axis A3 with a Z-shaped cross-section). The Z-shaped bending structures 3622 are all can increase the ability of the second reinforcement part 362 to resist deflection along the pivot axis A3. The Z-shaped bending structure 3622a also has some ability to resist deflection along a direction perpendicular to the pivot axis A3 (which helps the second support 36 to stably transmit force in this direction (perpendicular to the pivot axis A3)). Furthermore, the bridge connecting portion 368 spans the corresponding intermediate connecting portion of the rectangular outer frame portion of the first support 34 (also see FIG. 18 and FIG. 19). Therein, the intermediate connecting portion has a recess 350 (see FIG. 20). The recess 350 is located below the bridge connecting portion 368. The first reinforcement part 342 is exposed from the recess 350. When the first supper 34 and the second support 36 are stacked together, the bridge connecting portion 368 enters the recess 350. Furthermore, as shown by FIG. 18, FIG. 19, and FIG. 28, the second support body 360 (or the second support 36) has a plurality of holder shafts 372 and a plurality of base shafts 374, which are located on the plurality of supporting portions, in logic. A holder hole 373 is formed beside the holder shaft 372. A base hole 375 is formed beside the base shaft 374. The second support 36 is rotatably connected to the keycap 30 (or the holder hooks 304 thereof) through the holder shafts 372. The holder hooks 304 extend into the holder holes 373 correspondingly. The second support 36 is rotatably connected to the base plate 32 (or the base hooks 324 thereof) through the base shafts 374; therein, the base shaft 374 is rotatably hooked by the corresponding base hook 324, and the base hook 324 extends in to the corresponding base hole 175. In addition, the bridge connecting portion 368 is located on the side of the second support 36 used to be connected to the keycap 30. This structural configuration helps to improve the stability of the second support 36 supporting the keycap 30.

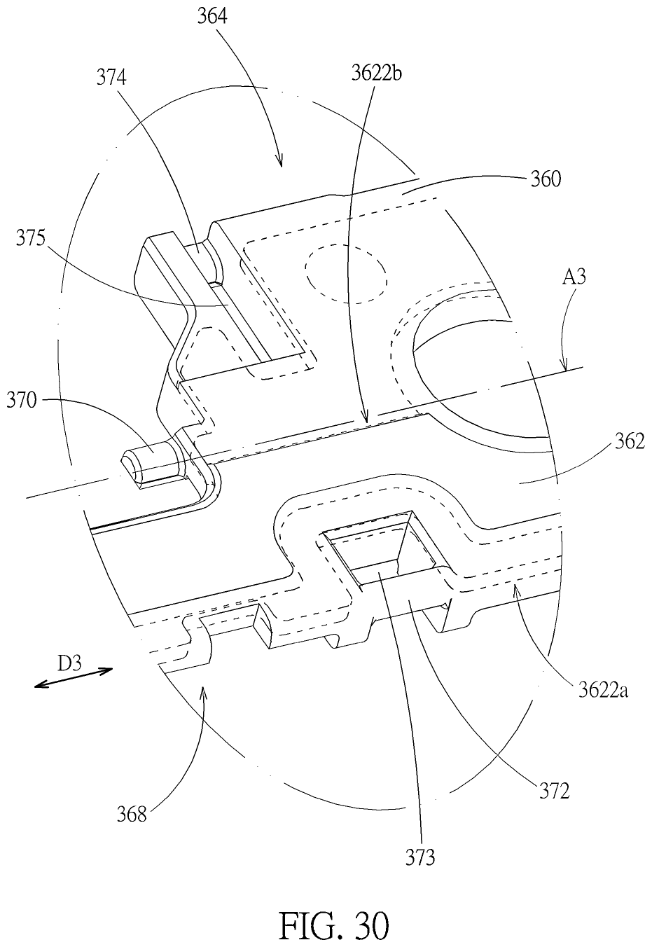

Please refer to FIG. 28 to FIG. 30; in FIG. 30, the hidden profile of the second reinforcement part 362 is partially shown in dashed lines. The second reinforcement part 362 (or the Z-shaped bending structures 3622a thereof) surrounds three sides of the holder hole 373 and does not extend into the holder shaft 372. This structural configuration helps to enhance the structural strength of the second support 36 here (that is, to strengthen the structure of the holder hole 373, which is conducive to the structural stability of the holder shaft 372), and is conducive to the stability of the connection between the holder shaft 372 and the keycap 30 at the holder hook 304. Therein, the Z-shaped bending structures 3622a there (i.e., the portion surrounding the holder hole 373) includes components extending parallel to the pivot axis A3 and extending perpendicular to the pivot axis A3, which further helps to reinforce the structure of the holder hole 373. However, it is not limited thereto in practice. For example, if the structural size design allows, the second reinforcement part 362 can also be designed to go through the holder shaft 372, which can further enhance the structural strength of the second support 36 at the holder hole 373 and the holder shaft 372, and also enhance the stability of the linkage between the second support 36 and the keycap 30. Furthermore, the second reinforcement part 362 is located on three sides of the base hole 375 (i.e., the left base hole 375 in FIG. 30) of the first portion 364, thereby reinforcing the structure of the base hole 375. In addition, the second reinforcement part 362 is also partially exposed from the second support body 360; therein, the second reinforcement part 362 is exposed from the upper surface of the second support body 360 (facing the keycap 30) and not exposed from the lower surface of the second support 360 (facing the base plate 32). This structural configuration can also effectively prevent the second reinforcement part 362 from directly colliding with the underlying components (such as the base plate 32) to cause sound (for example, the second reinforcement part 362 and the base plate 32 are both made of metal).

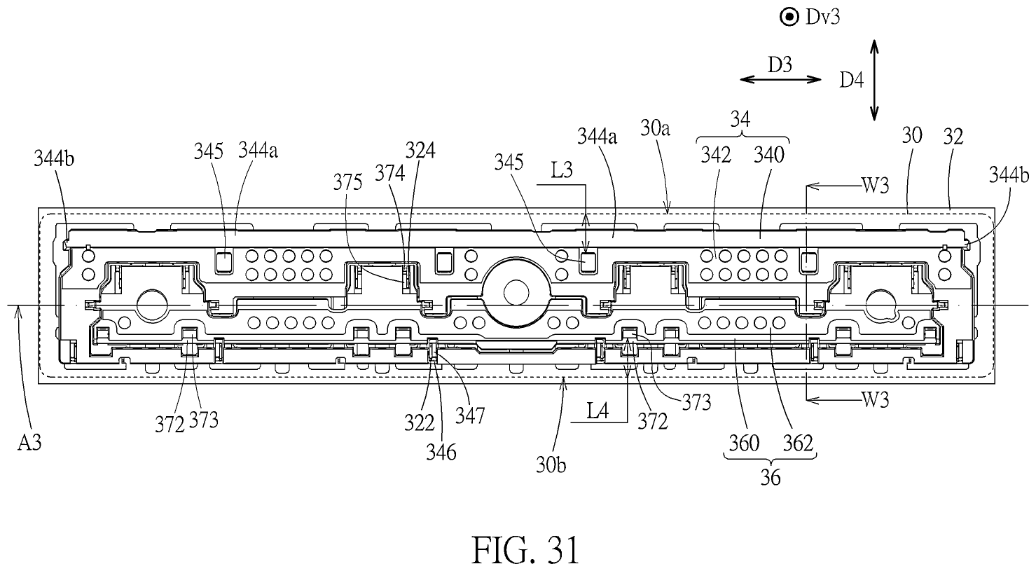

In addition, please refer to FIG. 20, FIG. 28 and FIG. 31; in FIG. 31, the profile of the keycap 30 is shown in dashed lines. In the second embodiment, a shaft diameter of the sliding shaft 344a (or the sliding shaft 344b) of the first support 34 is greater than a shaft diameter of the holder shaft 372 of the second support 36, which helps to enhance the stability of the rotation and sliding of the sliding shaft 344a (or the sliding shaft 344b). Furthermore, the keycap 30 has a first long side edge 30a and a second long side edge 30b. The first long side edge 30a and the second long side edge 30b both are parallel to the long side direction D3. In FIG. 31, the vertical direction Dv3 is perpendicular to the paper, so the structural profiles presented in the figure are equivalent to their vertical projections on the paper. In the second embodiment, there is a first distance L3 in the short side direction D4 between a projection of the sliding hole 345 of the first support 34 in the vertical direction Dv3 and a projection of the first long side edge 30a of the keycap 30 in the vertical direction Dv3. There is a second distance L4 in the short side direction D4 between a projection of the holder hole 373 of the second support 36 in the vertical direction Dv3 and a projection of the second long side edge 30b of the keycap 30 in the vertical direction Dv3. The first distance L3 is greater than the second distance L4. This structural configuration provides a larger space for the design of the structural and movement of the sliding shafts 344a of the first support 34.

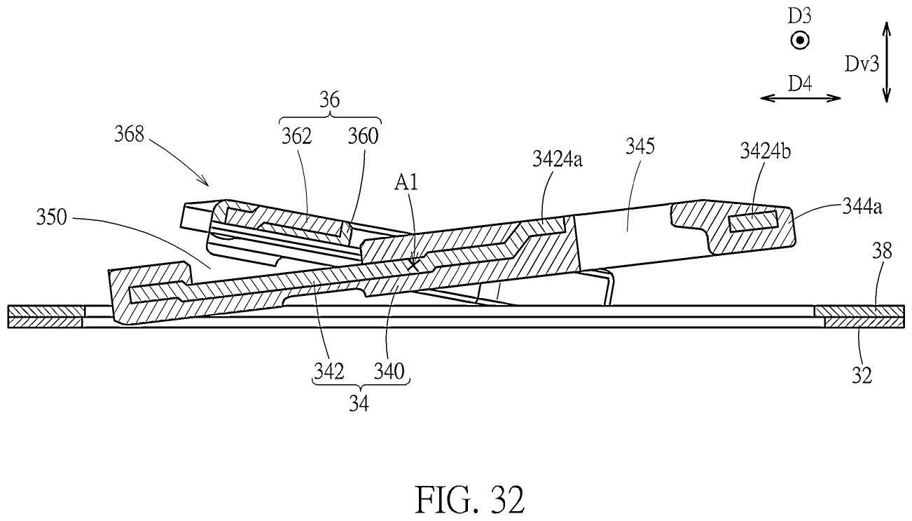

Furthermore, please refer to FIG. 20, FIG. 21, FIG. 28, FIG. 29 and FIG. 32; in FIG. 32, the keycap 30 is not shown to simplify the drawing. The first reinforcement part 342 and the second reinforcement part 362 overlap in the vertical direction Dv3. As shown by FIG. 32, a portion of the second support body 360 corresponding to the bridge connecting portion 368 separates the first reinforcement part 342 and the second reinforcement part 362 in the vertical direction Dv3, so that even if the first reinforcement part 342 is exposed from the recess 350, the second reinforcement part 362 can still be prevented from hitting the first reinforcement part 342 to cause sound.

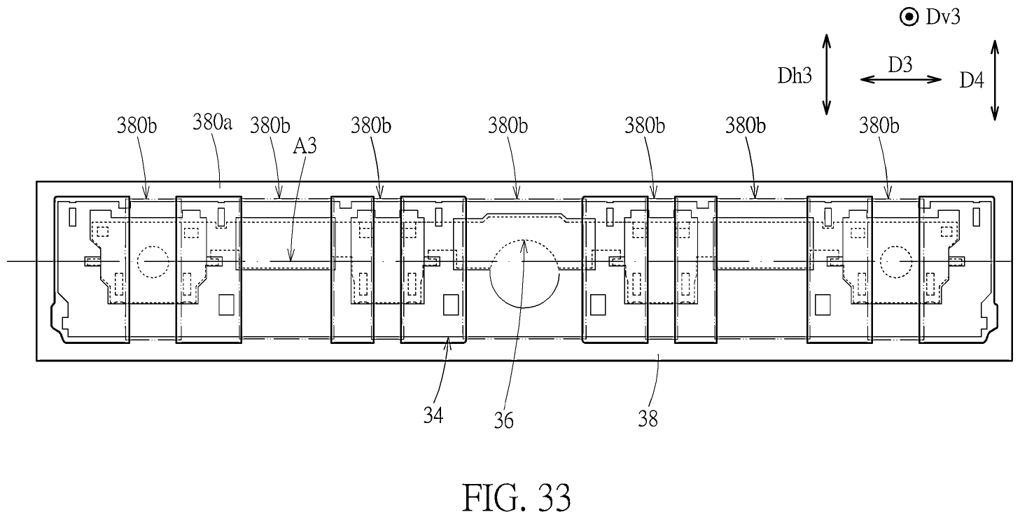

Please refer to FIG. 33, which is a top view of the switch circuit board 38; therein, the profile of the first support 34 is shown in thin lines, and the profile of the second support 36 is shown in dashed lines. The switch circuit board 38 includes a peripheral portion 380a and a plurality of circuit connecting portions 380b (of which the ranges are indicated by boxes in chain lines; the other portions of the switch circuit board 38 are the peripheral portion 380a). The circuit connecting portion 380b extends along a horizontal direction Dh3 (indicated by a double-headed arrow in the figure; that is, the length direction of the circuit connecting portion 380b is parallel to the horizontal direction Dh3) and connects opposite sides of the peripheral portion 380a. The horizontal direction Dh3 is perpendicular to the vertical direction Dv3 and the pivot axis A3; thus, the horizontal direction Dh3 is parallel to the short side direction D4. The switch circuit board 38 does not have a portion extending parallel to the pivot axis A3 inside the peripheral portion 380a. Compared with a switch circuit board (the inside of which usually contains vertical and horizontal connection structures) of a common keyswitch structure, there are only connection structures (i.e., circuit connecting portions 380b) extending in the same direction inside the switch circuit board 38, which reduces the degree of interference with the first support 34 and second support 36 structures. In the second embodiment, the ratio value of length to width of the keyswitch structure 3 is about 6. The keyswitch structure 3 uses seven circuit connecting portions 380b extending roughly parallel to the short side direction D4; however, it is not limited thereto in practice. Furthermore, the first support 34 and the second support 36 are located inside the peripheral portion 380a in the vertical direction Dv3; in other words, the first support 34 and the second support 36 do not overlap the peripheral portion 380a in the vertical direction Dv3. The circuit connecting portion 380b does not overlap some of the intermediate connecting portions of the first support 34 (e.g., the outermost intermediate connecting portion along the pivot axis A3) in the vertical direction Dv3, so that the structure of these intermediate connecting portions can be stretched downward to increase structural strength, which also increases the structural design flexibility of the reinforcement parts (such as the first reinforcement part 342) here.

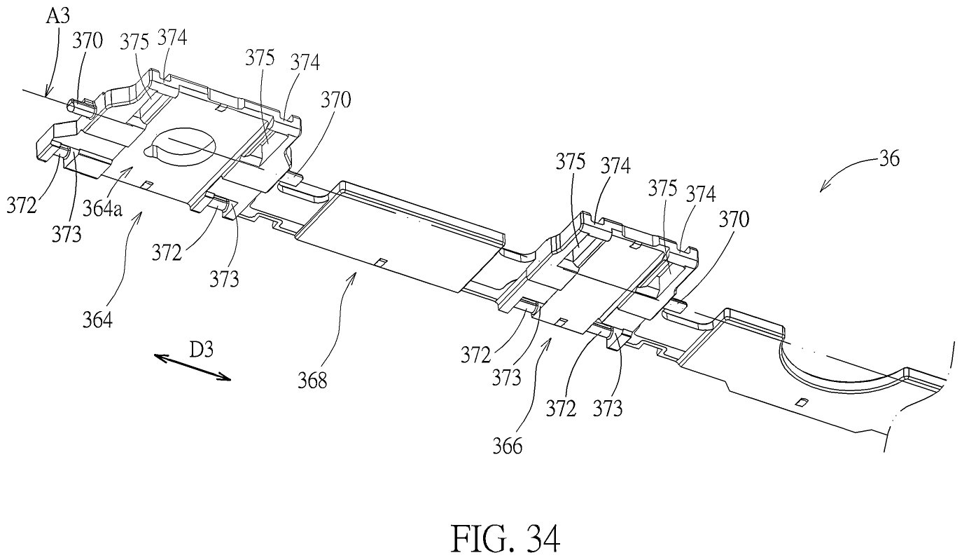

In addition, in the first embodiment, the supporting portions of the second support 36 overlap the circuit connecting portions 380b of the switch circuit board 38 in the vertical direction Dv3. Taking the first portion 364 of the second support 36 as an example, (please also refer to FIG. 34) the first portion 364 has a recess 364a. When the first support 34 and the second support 36 are stacked together, the corresponding circuit connecting portion 380b enters the recess 364a. On the other hand, through the design of the recess 364a, the first portion 364 can extend downward to increase its structural strength, which also increases the structural design flexibility of the reinforcement parts (such as the second reinforcement part 362) here. Thereby, this structural configuration can improve the structural strength of the first portion 364 and help to reduce the overall height of the keyswitch structure 3. The same goes for the second portion 366 and will not be repeatedly described. In addition, in the second embodiment, the rectangular outer frame portion of the first support 34 also overlaps the circuit connecting portion 380b of the switch circuit board 38 in the vertical direction Dv3. The rectangular outer frame portion has a recess correspondingly (e.g., the recess 352 shown in FIG. 20 and FIG. 21), so that when the first support 34 and the second support 36 are stacked together, the corresponding circuit connecting portion 380b also enters the recess 352. Similarly, this structural configuration can improve the structural strength of the rectangular outer frame portion of the first support 34 and help to reduce the overall height of the keyswitch structure 3.

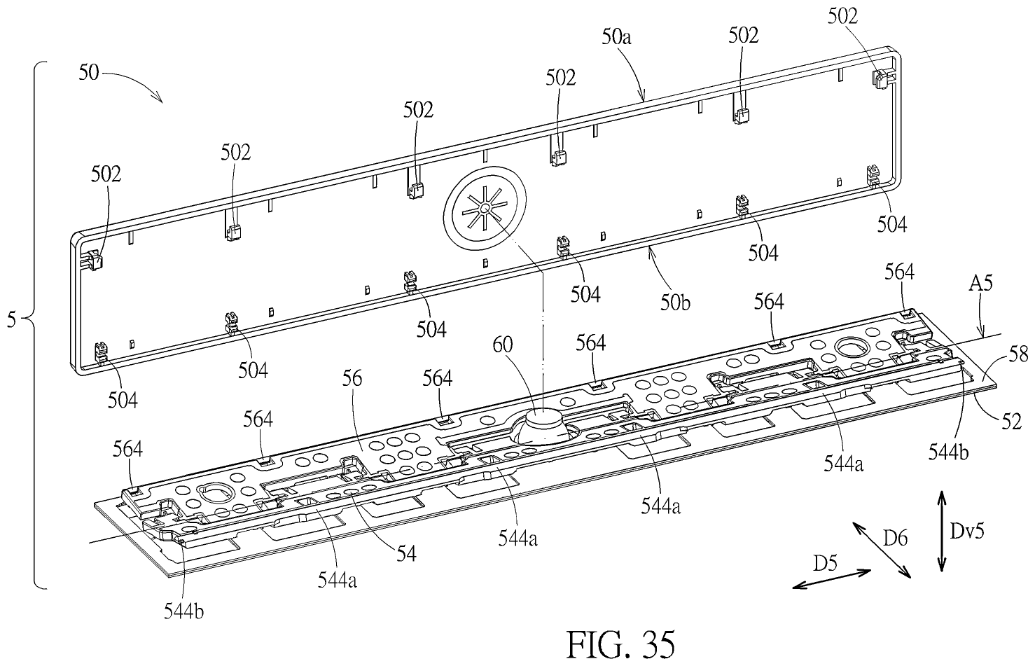

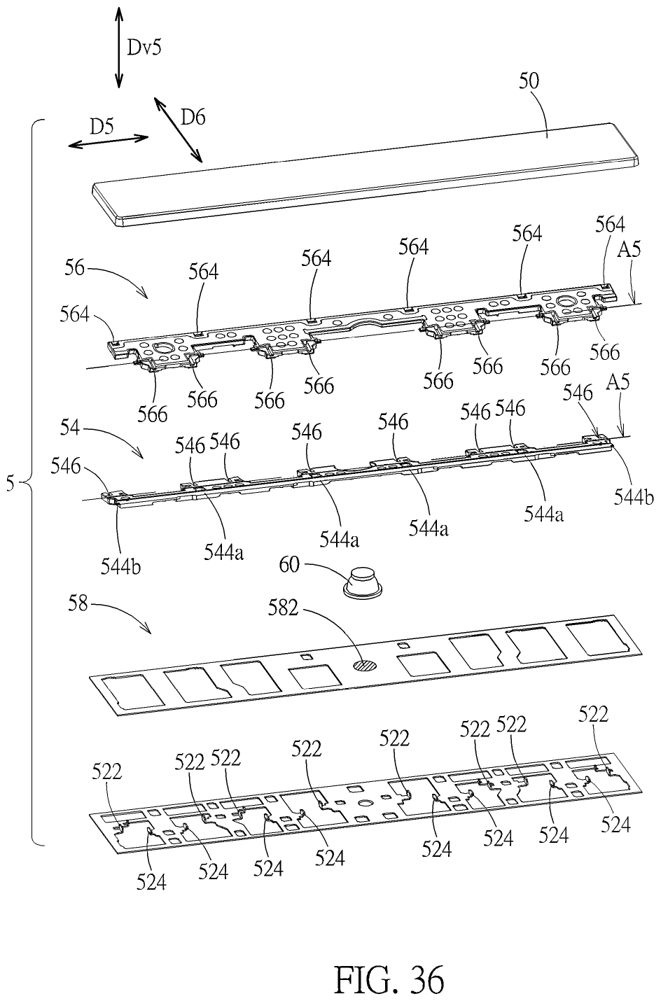

Please refer to FIG. 35 and FIG. 36. A keyswitch structure 5 according to a third embodiment is a long rectangular keyswitch structure, which has a long side direction D5 and a short side direction D6 (both are indicated by double-headed arrows in the figures). The long side direction D5 is perpendicular to the short side direction D6. In practice, the keyswitch structure 5 can be but is not limited to a space key. The keyswitch structure 5 includes a keycap 50, a base plate 52, a first support 54, a second support 56, a switch circuit board 58, and an elastic dome 60. The keycap 50 is disposed above the base plate 52. The first support 54 and the second support 56 are pivotally connected around a pivot axis A5 (indicated by a chain line). The pivot axis A5 is parallel to the long side direction D5. The first support 54 and the second support 56 are connected to the keycap 50 and the base plate 52 to support the keycap 50 above the base plate 52, so that the keycap 50 can move (e.g. moving up and down or parallel to a vertical direction Dv5) relative to the base plate 52 through the first support 54 and the second support 56. The vertical direction Dv5 (indicated by a double-headed arrow in the figures) is perpendicular to the long side direction D5 and the short side direction D6. The switch circuit board 58 is placed on the base plate 52. The switch circuit board 58 can be but not limited to a membrane circuit board, and has a switch 582 (shown as a circle filled with oblique lines in the figure), roughly corresponding to the center of the keycap 50. The elastic dome 60 corresponds to the switch 582 and is disposed on switch circuit board 58 and below the keycap 50. The keycap 50 can be pressed to move toward the base plate 52, and then squeezes the elastic dome 60 to trigger the switch 582 downward. Therefore, in logic, the combination of the first support 54 and the second support 56 or the combination of the first support 54, the second support 56, and the base plate 52 can be regarded as a keycap lifting mechanism.

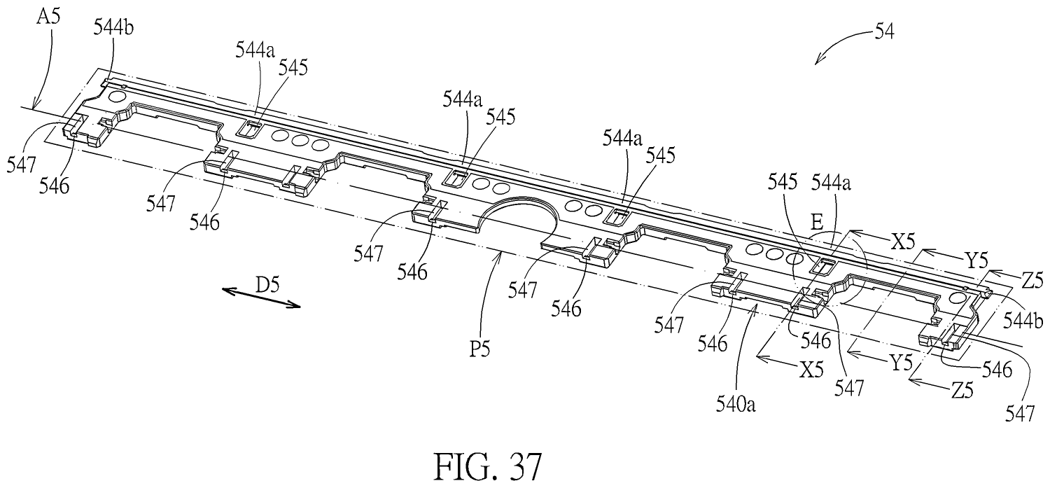

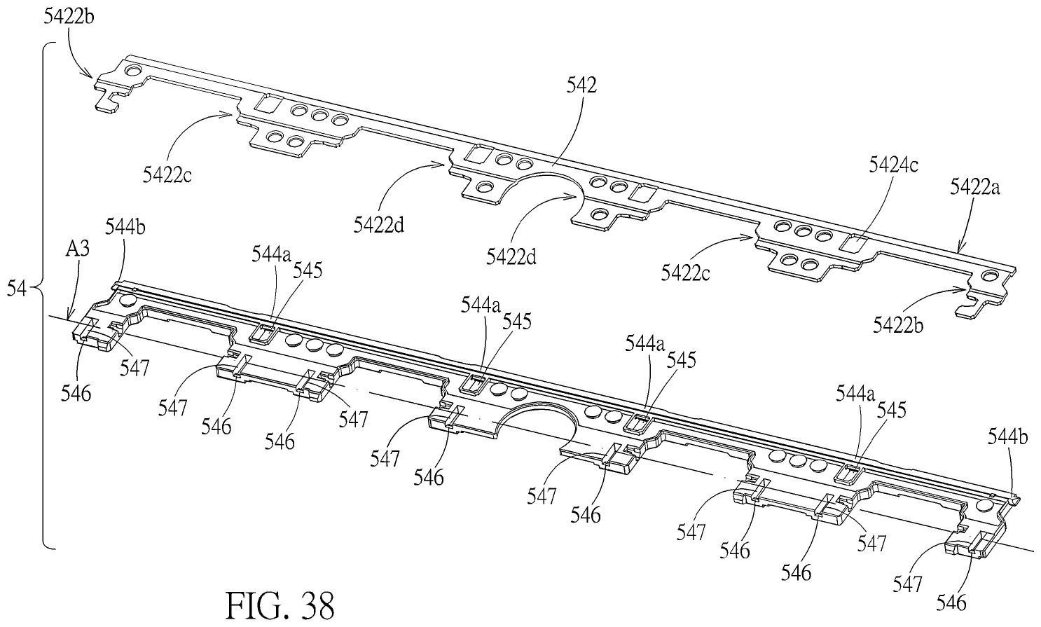

For further details, please refer to FIG. 37 and FIG. 38. The first support 54 includes a first support body 540 and a first reinforcement part 542. The first reinforcement part 542 is embedded into the first support body 540. An elastic modulus of the first reinforcement part 542 is greater than an elastic modulus of the first support body 540. Thereby, the first reinforcement part 542 has the effect of reinforcing the structure of the first support 54. Furthermore, in the third embodiment, the first support body 540 as a whole includes a long arm extending roughly parallel to the pivot axis A5 and a plurality of support arms protruding from the long arm perpendicular to the long arm. The first support 54 is connected to the keycap 50 through the long arm of the first support body 540, and is connected to the base plate 52 through the support arms (or the ends thereof) of the first support body 540. The first reinforcement part 542 as a whole includes a long arm and a plurality of support arms protruding from the long arm perpendicular to the long arm. The long arm of the first reinforcement part 542 extends parallel to the pivot axis A5 in the long arm of the first support body 540. The support arms of the first reinforcement part 542 extend in the support arms of the first support body 540. The first reinforcement part 542 includes a plurality of Z-shaped bending structures 5422a˜d, which all extend parallel to the pivot axis A5 (or in other words, the Z-shaped bending structures 5422a˜d extend parallel to the pivot axis A5 with a Z-shaped cross-section), thereby increasing the ability of the first reinforcement part 542 to resist deflection along the pivot axis A5, and also enhancing the linkage of the keycap lifting mechanism (including the mutually pivoted first support 54 and second support 56) in the long side direction D5 (or in other words, increasing the efficiency of transmitting force in the long side direction D5). Therein, the Z-shaped bending structure 5422a is located on the long arm of the first reinforcement part 542, and the Z-shaped bending structures 5422b˜d are located on the plurality of support arms of the first reinforcement part 542. The Z-shaped bending structures 5422a d all can further enhance the structural reinforcing effect of the first reinforcement part 542 on the first support body 540.

Furthermore, as shown by FIG. 35 and FIG. 37, the first support body 540 (or the first support 54) has a plurality of sliding shafts 544a and 544b (on the long arm of the first support body 540) and a plurality of base shafts 546 (on the ends of the support arms of the first support body 540). A sliding hole 545 is formed beside the sliding shaft 544a. A base hole 547 is formed beside the base shaft 546. The first support 54 is slidably and rotatably connected to the keycap 50 (or sliding hooks 502 thereof) through the sliding shafts 544a and 544b, and the sliding hooks 502 extend into the sliding holes 545 correspondingly. The first support 54 is rotatably connected to the base plate 52 (or base hooks 522 thereof) through the base shafts 546; therein, the base shafts 546 are rotatably hooked by the base hooks 522 correspondingly, and the base hooks 522 extend into the base holes 547 correspondingly.

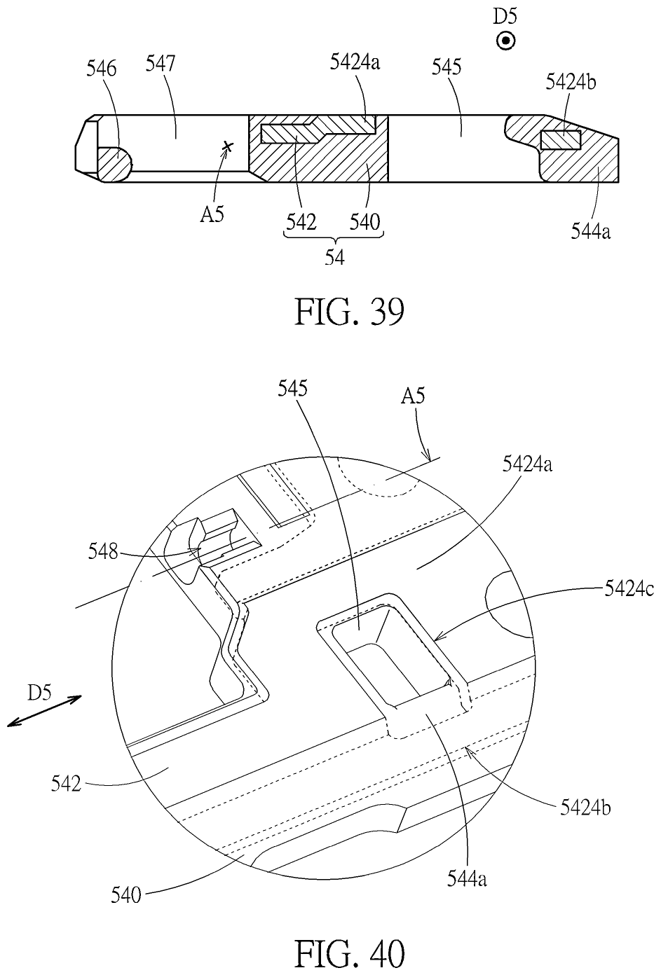

Please refer to FIG. 37 to FIG. 40; in FIG. 40, the hidden profile of the first reinforcement part 542 is partially shown in dashed lines. The first reinforcement part 542 surrounds the sliding hole 545 and goes through the sliding shaft 544a, thereby enhancing the structural strength of the first support 54 at the sliding hole 545 and the sliding shaft 544a, and also improving the stability of the mutual linkage between the first support 54 and the keycap 50. In the third embodiment, the first reinforcement part 542 uses the Z-shaped bending structure 5422a to achieve the above structural configuration, but it is not limited to thereto in practice. Therein, the Z-shaped bending structure 5422a is located on a side fringe of the first reinforcement part 542 and is distributed throughout the side fringe. The Z-shaped bending structure 5422a includes a first plate portion 5424a and a second plate portion 5424b at the circle E in FIG. 37. The first plate portion 5424a and the second plate portion 5424b are not coplanar. The first plate portion 5424a and the second plate portion 5424b are connected to form a through hole 5424c. The sliding hole 545 is located inside the through hole 5424c. The second plate portion 5424b goes through the sliding shaft 544a. Furthermore, as shown by FIG. 39, the sliding shaft 544a extends parallel to pivot axis A5 with a non-rectangular cross-section. In the third embodiment, the non-rectangular cross-section is roughly trapezoidal, so that the thickness of the sliding shaft 544a gradually decreases in the direction away from pivot axis A5, which can effectively reduce the degree of the structural interference between the sliding shaft 544a and the keycap 50. That the second plate portion 5424b goes through the sliding shaft 544a can compensate for the reduction in the structural strength of the sliding shaft 544a caused by the gradual decrease in thickness, and can even further enhance the structural strength of the sliding shaft 544a.

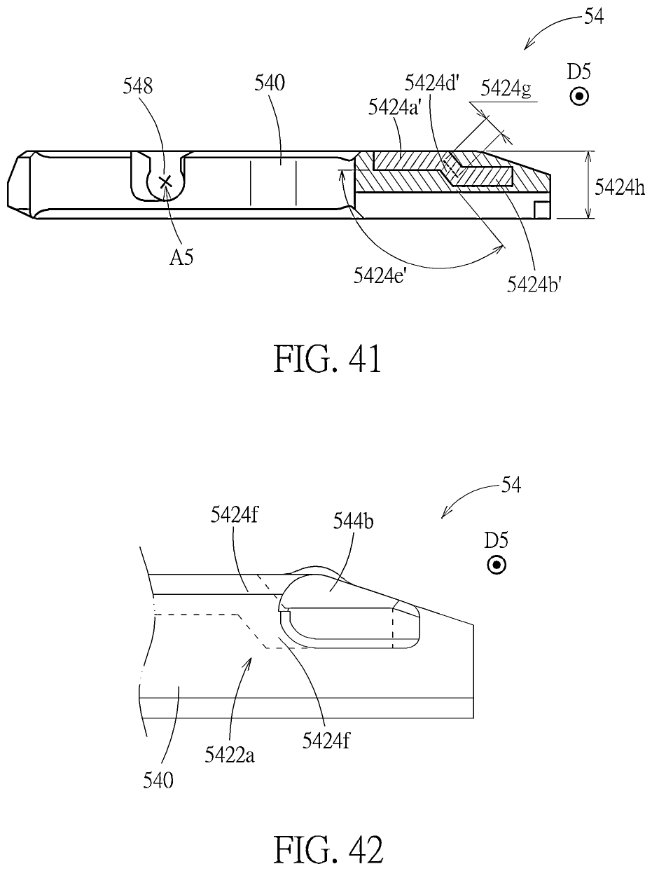

On the other hand, the first support body 540 has a side fringe (i.e., the long side that is connected to the keycap 50), of which the thickness gradually decreases in the direction away from the pivot axis A5, which can effectively reduce the degree of the structural interference between the first support body 540 and the keycap 50. The Z-shaped bending structure 5422a can extend perpendicular to the pivot axis A5 into the side fringe through its structural bending characteristics, which can compensate for the reduction in the structural strength of the side fringe due to the gradual decrease in thickness, and can even further enhance the structural strength of the side fringe. Furthermore, take the first support 54 at the line Y5-Y5 in FIG. 37 as an example. As shown by FIG. 41, the Z-shaped bending structure 5422a includes a first plate portion 5424a′, a second plate portion 5424b′, and a connecting plate portion 5424d′. The first plate portion 5424a′, the second plate portion 5424b′, and the connecting plate portion 5424d′ extend parallel to the pivot axis A5 and are not coplanar. The first plate portion 5424a′ and the second plate portion 5424b′ are connected to opposite sides of the connecting plate portion 5424d′. The first plate portion 5424a′ is exposed from the first support body 540. The second plate portion 5424b′ extends in the side fringe. Furthermore, in the third embodiment, an included angle 5424e′ is formed by the first plate portion 5424a′ and the connecting plate portion 5424d′ (i.e. a bending angle). The included angle 5424e′ is greater than 90 degrees, e.g., 120 degrees. However, it is not limited thereto in practice. For example, the included angle 5424e′ is between 40 degrees and 90 degrees. This description about the bending angle also applies to the included angle between the second plate portion 5424b′ and the connecting plate portion 5424d′, which will not be described repeatedly. In addition, the ratio value of a length 5424g (shown as a dashed line in the figure) of the connecting plate portion 5424d′ to a thickness 5424h of the first support 54 at the bend may be, but is not limited to, 0.5 to 1.5 in practice.

Furthermore, please refer to FIG. 37, FIG. 38, and FIG. 42; in FIG. 42, the hidden profile of the Z-shaped bending structure 5422a is shown in dashed lines. Although the Z-shaped bending structure 5422a does not directly go through the sliding shaft 544b, the Z-shaped bending structure 5422a and the sliding shaft 544b overlap in a direction parallel to the pivot axis A5. This structural configuration is also conducive to the connection stability of the sliding shaft 544b and the corresponding sliding hook 502 of the keycap 50. Furthermore, as shown by FIG. 42, in the third embodiment, two bending portions 5424f of the Z-shaped bending structure 5422a both overlap the sliding shaft 544b in a direction parallel to the pivot axis A5, which is conducive to the stability of the connection of the sliding shafts 544b with the sliding hooks 502 of the keycap 50.

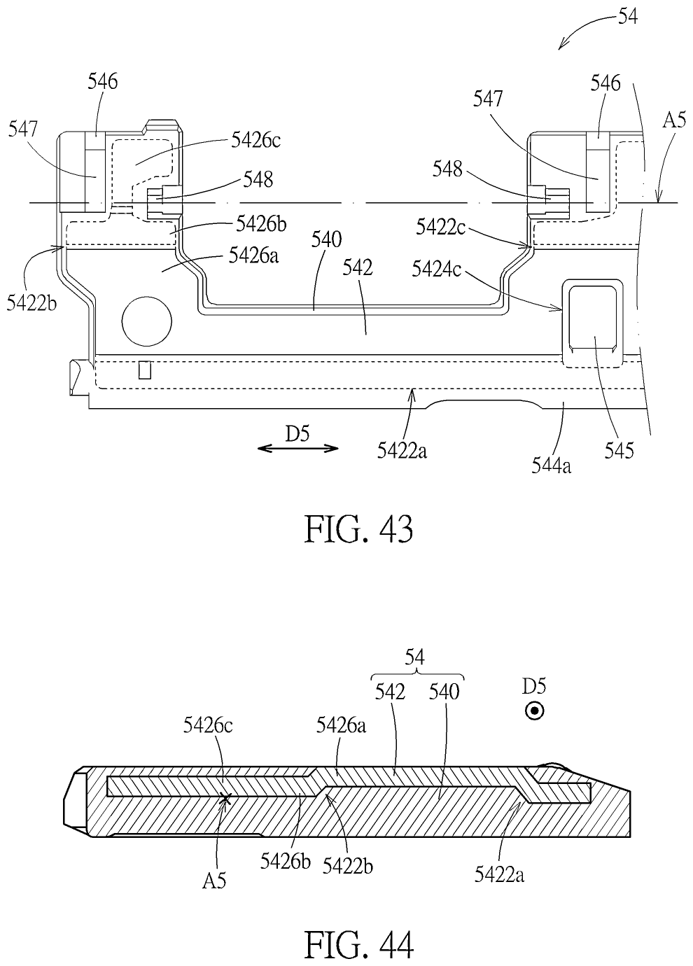

In addition, please refer to FIG. 37, FIG. 38, FIG. 43 and FIG. 44; in FIG. 43, the hidden profile of the first reinforcement part 542 is partially shown in dashed lines. The first support body 540 (or the first support 54) has a plurality of pivot holes 548. The pivot hole 548 may be realized by, but not limited to, a pair of oppositely arranged hooks. However, it is not limited thereto in practice. The first support 54 is pivotally connected with the second support 56 through the plurality of pivot holes 548. As shown by FIG. 43 and FIG. 44, the Z-shaped bending structure 5422b includes a first plate portion 5426a and a second plate portion 5426b. The first plate portion 5426a and the second plate portion 5426b are not coplanar. The first plate portion 5426a is exposed from the first support body 540. The second plate portion 5426b is embedded in the first support body 540. The first reinforcement part 542 has a surrounding portion 5426c at the Z-shaped bending structure 5422b (or logically, it can also be regarded as the surrounding portion 5426c extending from the second plate portion 5426b or formed on the second plate portion 5426b). The surrounding portion 5426c surrounds three sides of the adjacent pivot hole 548 (from the viewpoint of FIG. 43, i.e., the upper side, the left side and the lower side). This structural configuration can increase the structural strength of the pivot hole 548 and improve the stability of the pivot connection between the first support 54 and the second support 56. Furthermore, in the third embodiment, the surrounding portion 5426c is not exposed from the first support body 540. Besides, the surrounding portion 5426c overlaps the pivot hole 548 in a direction parallel to the pivot axis A5, but it is not limited thereto in practice. In addition, bending portions of the Z-shaped bending structure 5422b are adjacent to the pivot hole 548. This structural configuration has the effect of reinforcing the structure of the pivot hole 548. In practice, the position of Z-shaped bending structure 5422b can be modified (as shown by the two chain lines in FIG. 43) so that its bending portions overlap with the pivot hole 548 in a direction parallel to the pivot axis A5 (which also makes the bending portions overlap with a pivot that is inserted into the pivot hole 548), which can further enhance the structural reinforcing effect of the Z-shaped bending structure 5422b on pivot hole 548. At this time, the surrounding portion 5426c is formed on the bending portions of the Z-shaped bending structure 5422b.

As described above, in the third embodiment, the first reinforcement part 542 is partially exposed from the first support body 540. Therein, as shown by FIG. 37, the first support 54 as a whole extends along a reference plane P5 (shown in chain lines; in principle, the reference plane P5 can be regarded as a plane containing the pivot axis A5). The first support body 540 has an upper surface (facing the keycap 50) and a lower surface (facing the base plate 52) in a direction perpendicular to the reference plane P5. The first reinforcement part 542 is exposed from the upper surface and not exposed from the lower surface. This structural configuration can effectively prevent the first reinforcement part 542 from directly colliding with the underlying components (such as the base plate 52) to cause sound (for example, the first reinforcement part 542 and the base plate 52 are both made of metal). However, it is not limited thereto in practice. In addition, the description about the bending angle of the Z-shaped bending structure 5422a is also applicable here if there is no contradiction with the Z-shaped bending structure 5422b˜d, which will not be repeated in addition.

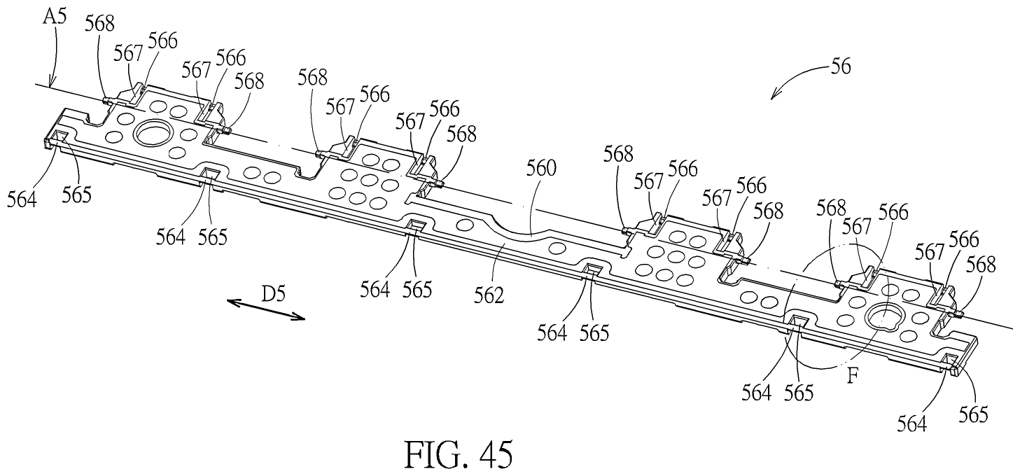

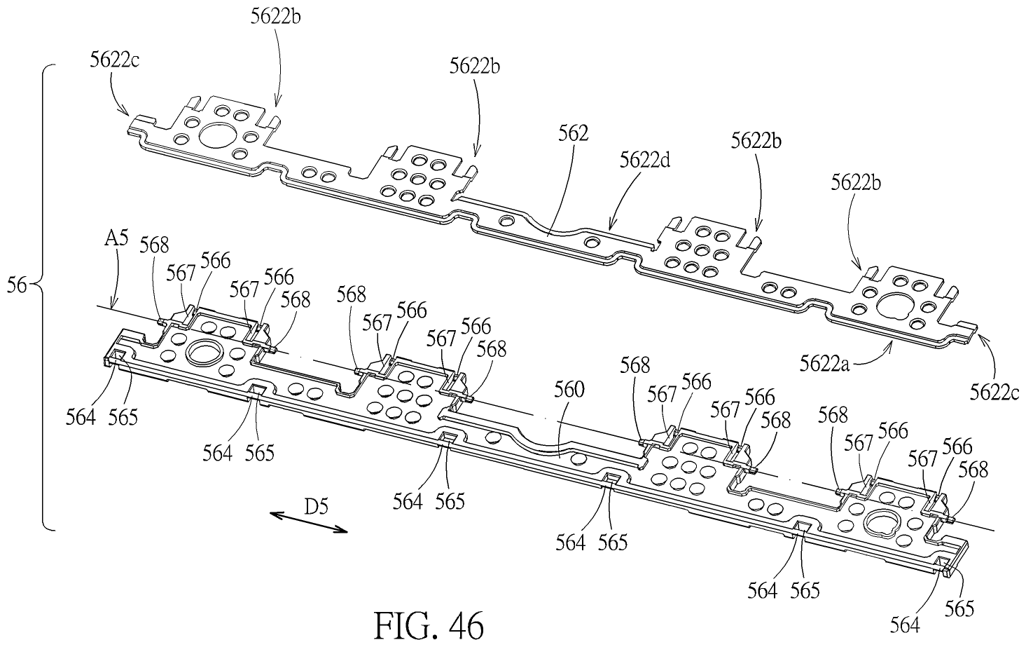

Please refer to FIG. 45 and FIG. 46. The second support 56 includes a second support body 560 and a second reinforcement part 562. The second reinforcement part 562 is embedded into the second support body 560. An elastic modulus of the second reinforcement part 562 is greater than an elastic modulus of the second support body 560. Similarly, the second reinforcement part 562 also has the effect of reinforcing the structure of the second support 56. Furthermore, in the third embodiment, the second support body 560 as a whole includes a long arm extending roughly parallel to the pivot axis A5 and a plurality of support arms protruding from the long arm perpendicular to the long arm. The second support 56 is connected to the keycap 50 through the long arm of the second support body 560, and is connected to the base plate 52 through the support arms (or the ends thereof) of the second support body 560. The second reinforcement part 562 as a whole includes a long arm and a plurality of support arms protruding from the long arm perpendicular to the long arm. The long arm of the second reinforcement part 562 extends parallel to the pivot axis A5 in the long arm of the second support body 560. The support arms of the second reinforcement part 562 extend in the support arms of the second support body 560. The second reinforcement part 562 includes a plurality of Z-shaped bending structures 5622a˜d. Therein, the Z-shaped bending structure 5622a extends along an edge (close to the keycap 50) of the second reinforcement part 562 (including a component extending parallel to the pivot axis A5 and a component extending perpendicular to the pivot axis A5). The Z-shaped bending structures 5622b˜d extend parallel to the pivot axis A5 (or in other words, the Z-shaped bending structures 5622b˜d extend parallel to the pivot axis A5 with a Z-shaped cross-section). The Z-shaped bending structures 5622a˜d all can increase the ability of the second reinforcement part 562 to resist deflection along the pivot axis A5, and also enhancing the linkage of the keycap lifting mechanism (including the mutually pivoted first support 54 and second support 56) in the long side direction D5 (or in other words, increasing the efficiency of transmitting force in the long side direction D5). The Z-shaped bending structure 5622a also has some ability to resist deflection along a direction perpendicular to the pivot axis A5 (which helps the second support 56 to stably transmit force in this direction (perpendicular to the pivot axis A5)). The Z-shaped bending structures 5622a˜d all can further enhance the structural reinforcing effect of the first reinforcement part 562 on the first support body 560.

Furthermore, as shown by FIG. 35 and FIG. 45, the second support body 560 (or the second support 56) has a plurality of holder shafts 564 (on the long arm of the second support body 560) and a plurality of base shafts 566 (on ends of the support arms of the second support body 560). A holder hole 565 is formed beside the holder shaft 564. A base hole 567 is formed beside the base shaft 566. The second support 56 is rotatably connected to the keycap 50 (or holder hooks 504 thereof) through the holder shafts 564, and the holder hooks 504 extend into the holder holes 565 correspondingly. The second support 56 is rotatably connected to the base plate 52 (or base hooks 524 thereof) through the base shafts 566; therein, the base shafts 566 are rotatably hooked by the base hooks 524 correspondingly, and the base hooks 524 extend into the base holes 567 correspondingly. Furthermore, pivots 568 are provided on two sides of the support arm of the second support body 560 along the pivot axis A5. The first support 54 and the second support 56 are staggered along the pivot axis A5, and are pivotally connected by inserting the pivots 568 into the pivot holes 548. On the other hand, the first support 54 is located on opposite outer sides of the second support 56 on the pivot axis A5. In logic, the first support 54 can be regarded as an outer support, and the second support 56 can be regarded as an inner support.

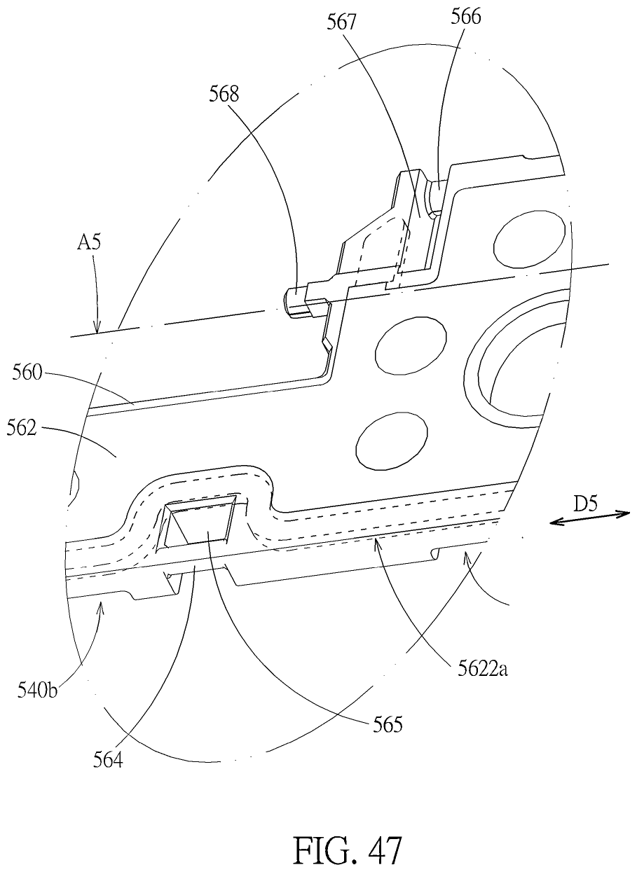

Please refer to FIG. 45 to FIG. 47; in FIG. 47, the hidden profile of the second reinforcement part 562 is partially shown in dashed lines. The second reinforcement part 562 (or the Z-shaped bending structures 5622a thereof) surrounds three sides of the holder hole 565 and does not extend into the holder shaft 564. This structural configuration helps to enhance the structural strength of the second support 56 here (that is, to strengthen the structure of the holder hole 565, which is conducive to the structural stability of the holder shaft 564), and is conducive to the stability of the connection between the holder shaft 564 and the keycap 50 at the holder hook 504. Therein, the Z-shaped bending structures 5622a there (i.e., the portion surrounding the holder hole 565) includes components extending parallel to the pivot axis A5 and extending perpendicular to the pivot axis A5, which further helps to reinforce the structure of the holder hole 565. However, it is not limited thereto in practice. For example, if the structural size design allows, the second reinforcement part 562 can also be designed to go through the holder shaft 564, which can further enhance the structural strength of the second support 56 at the holder hole 565 and the holder shaft 564, and also enhance the stability of the linkage between the second support 56 and the keycap 50. Furthermore, the second reinforcement part 562 is located on three sides of the base hole 567, thereby reinforcing the structure of the base hole 567. In addition, the second reinforcement part 562 is also partially exposed from the second support body 560. Therein, the second reinforcement part 562 is exposed from the upper surface (facing the keycap 50) of the second support body 560 and not exposed from the lower surface (facing the base plate 52) of the second support body 560. This structural configuration can also effectively prevent the second reinforcement part 562 from directly colliding with the underlying components (such as the base plate 52) to cause sound (for example, the second reinforcement part 562 and the base plate 52 are both made of metal).

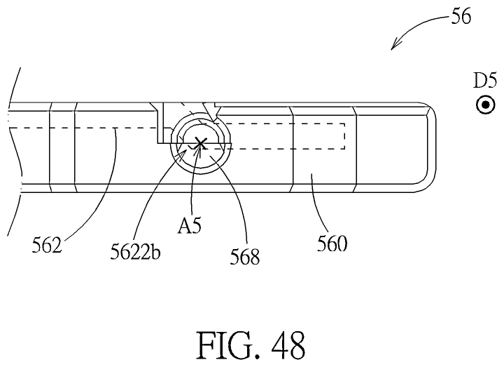

Furthermore, please refer to FIG. 48; therein, the hidden profile of the Z-shaped bending structures 5622b is shown in dashed lines. Two bending portions of the Z-shaped bending structure 5622b both overlap the sliding shaft 568 in a direction parallel to the pivot axis A5, which is conducive to the stability of the connection of the sliding shafts 568 with the pivot holes 548 of the first support 54.

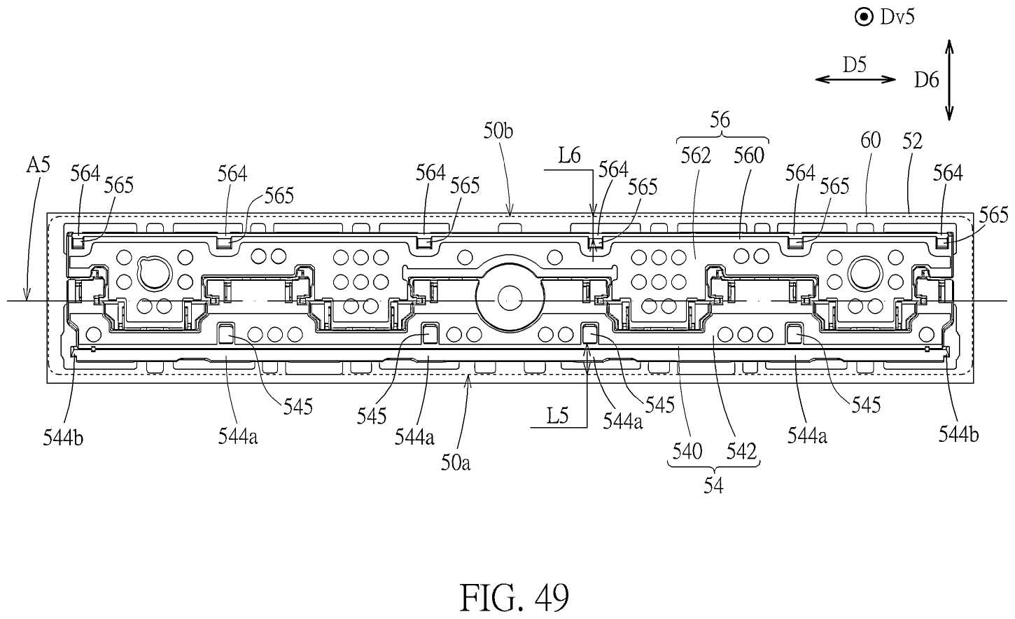

In addition, please refer to FIG. 37, FIG. 45 and FIG. 49; in FIG. 49, the profile of the keycap 50 is shown in dashed lines. In the third embodiment, a shaft diameter of the sliding shaft 544a (or the sliding shaft 544b) of the first support 54 is greater than a shaft diameter of the holder shaft 564 of the second support 56, which helps to enhance the stability of the rotation and sliding of the sliding shaft 544a (or the sliding shaft 544b). Furthermore, the keycap 50 has a first long side edge 50a and a second long side edge 50b. The first long side edge 50a and the second long side edge 50b both are parallel to the long side direction D5. In FIG. 49, the vertical direction Dv5 is perpendicular to the paper, so the structural profiles presented in the figure are equivalent to their vertical projections on the paper. In the third embodiment, there is a first distance L5 in the short side direction D6 between a projection of the sliding hole 545 of the first support 54 in the vertical direction Dv5 and a projection of the first long side edge 50a of the keycap 50 in the vertical direction Dv5. There is a second distance L6 in the short side direction D6 between a projection of the holder hole 565 of the second support 56 in the vertical direction Dv5 and a projection of the second long side edge 50b of the keycap 50 in the vertical direction Dv5. The first distance L5 is greater than the second distance L6. This structural configuration provides a larger space for the design of the structural and movement of the sliding shafts 544a of the first support 54.

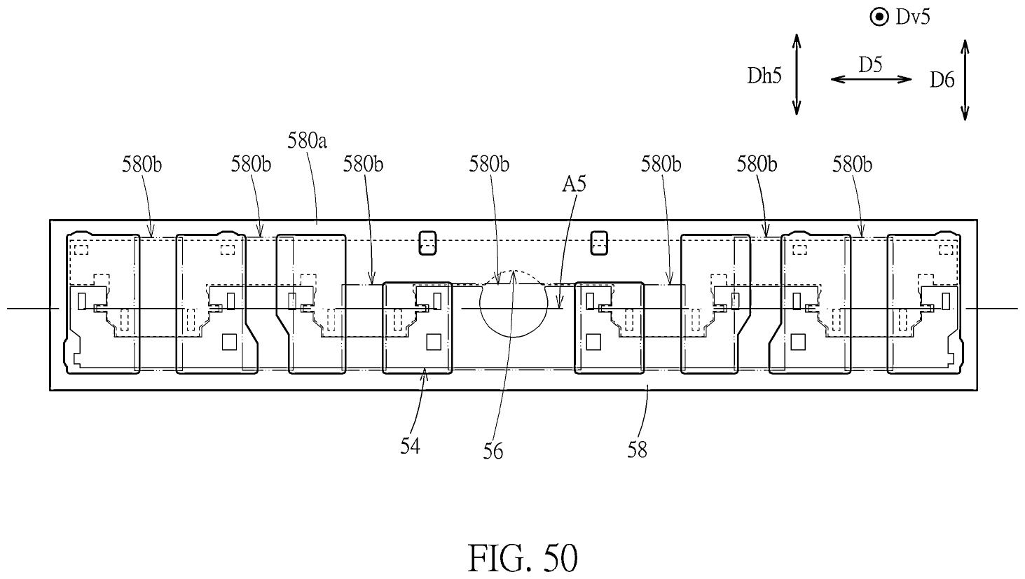

Please refer to FIG. 50, which is a top view of the switch circuit board 58; therein, the profile of the first support 54 is shown in thin lines, and the profile of the second support 56 is shown in dashed lines. The switch circuit board 58 includes a peripheral portion 580a and a plurality of circuit connecting portions 580b (of which the ranges are indicated by boxes in chain lines; the other portions of the switch circuit board 58 are the peripheral portion 580a). The circuit connecting portion 580b extends along a horizontal direction Dh5 (indicated by a double-headed arrow in the figure; that is, the length direction of the circuit connecting portion 580b is parallel to the horizontal direction Dh5) and connects opposite sides of the peripheral portion 580a. The horizontal direction Dh5 is perpendicular to the vertical direction Dv5 and the pivot axis A5; thus, the horizontal direction Dh5 is parallel to the short side direction D6. The switch circuit board 58 does not have a portion extending parallel to the pivot axis A5 inside the peripheral portion 580a. Compared with a switch circuit board (the inside of which usually contains vertical and horizontal connection structures) of a common keyswitch structure, there are only connection structures (i.e., circuit connecting portions 580b) extending in the same direction inside the switch circuit board 58, which reduces the degree of interference with the first support 54 and second support 56 structures. In the third embodiment, the ratio value of length to width of the keyswitch structure 5 is about 6. The keyswitch structure 5 uses seven circuit connecting portions 580b extending roughly parallel to the short side direction D6; however, it is not limited thereto in practice. Furthermore, most of the first support 54 and the second support 56 are located inside the peripheral portion 580a in the vertical direction Dv5; in other words, the first support 54 and the second support 56 only partially overlap the peripheral portion 580a in the vertical direction Dv5.

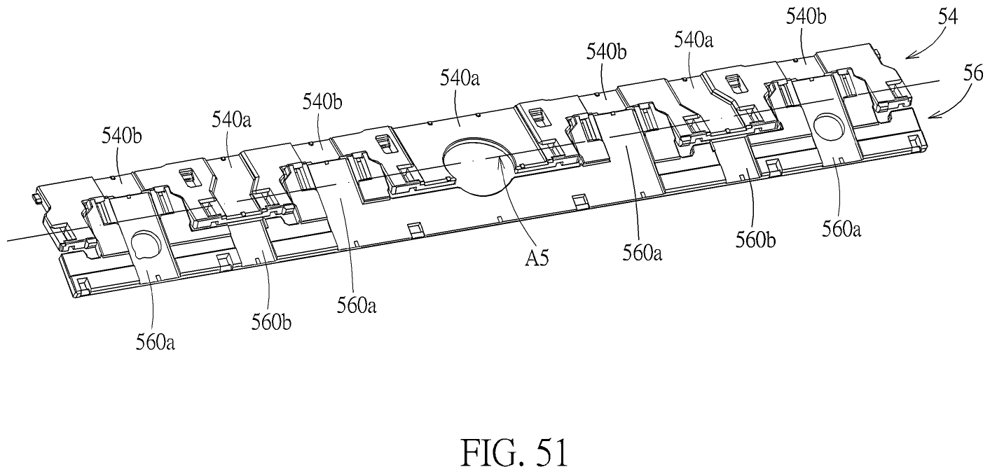

In addition, in the third embodiment, the first support body 540 (of the first support 54) and the second support body 560 (of the second support 56) overlap the circuit connecting portion 580b of the switch circuit board 58 in the vertical direction Dv5. Please also refer to FIG. 51, which is a schematic diagram illustrating the bottoms of the first support 54 and the second support 56. The first support body 540 has a plurality of recesses 540a and 540b. The second support body 560 has a plurality of recesses 560a and 560b. When the first support 54 and the second support 56 lie flat, the circuit connecting portions 580b enter the recesses 540a, 540b, 560a and 560b correspondingly. On the other hand, by the design of the recesses 540a, 540b, 560a and 560b, the first support 54 and the second support 56 can be stretched downward to increase structural strength, which also increases the structural design flexibility of the reinforcement parts (such as the first reinforcement part 542 and the second reinforcement part 562) here. Thereby, this structural configuration can improve the structural strength of the first support 54 and the second support 56 and help to reduce the overall height of the keyswitch structure 5.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keycap lifting mechanism, comprising:
a first support, the first support comprising a first support body and a first reinforcement part, the first reinforcement part being embedded into the first support body, an elastic modulus of the first reinforcement being greater than an elastic modulus of the first support body; and
a second support, the second support and the first support being pivotally connected around a pivot axis;
wherein the first reinforcement part comprises a Z-shaped bending structure, and the Z-shaped bending structure extends parallel to the pivot axis.

2. The keycap lifting mechanism according to claim 1, wherein the Z-shaped bending structure is located on a side fringe of the first reinforcement part, the first support has a sliding shaft, and the Z-shaped bending structure and the sliding shaft overlap in a direction parallel to the pivot axis.

3. The keycap lifting mechanism according to claim 2, wherein the Z-shaped bending structure comprises two bending portions, and the sliding shaft and one of the two bending portions overlap in the direction parallel to the pivot axis.

4. The keycap lifting mechanism according to claim 1, wherein the first support has a pivot, the first support is pivotally connected to the second support through the pivot, the Z-shaped bending structure comprises two bending portions, and the pivot and one of the two bending portions overlap in a direction parallel to the pivot axis.

5. The keycap lifting mechanism according to claim 1, wherein the Z-shaped bending structure comprises a first plate portion, a second plate portion, and a connecting plate portion, the first plate portion, the second plate portion, and the connecting plate portion extend parallel to the pivot axis and are not coplanar, the first plate portion and the second plate portion are connected to opposite sides of the connecting plate portion, the first support body has a side fringe, a thickness of the side fringe gradually decreases in a direction away from the pivot axis, the first plate portion is exposed from the first support body, and the second plate portion extends in the side fringe.

6. The keycap lifting mechanism according to claim 1, wherein the first support as a whole extends along a reference plane, the first support body has an upper surface and a lower surface in a direction perpendicular to the reference plane, and the first reinforcement part is exposed from the upper surface and not exposed from the lower surface.

7. The keycap lifting mechanism according to claim 1, wherein the Z-shaped bending structure comprises a first plate portion, a second plate portion, and a connecting plate portion, the first plate portion, the second plate portion, and the connecting plate portion extend parallel to the pivot axis and are not coplanar, the first plate portion and the second plate portion are connected to opposite sides of the connecting plate portion, an included angle is formed by the first plate portion and the connecting plate portion, and the included angle is greater than 90 degrees.

8. The keycap lifting mechanism according to claim 1, wherein the first reinforcement part comprises another Z-shaped bending structure, extending perpendicular to the pivot axis.

9. The keycap lifting mechanism according to claim 1, wherein the second support comprises a second support body and a second reinforcement part, the second reinforcement part is embedded into the second support body, an elastic modulus of the second reinforcement is greater than an elastic modulus of the second support body, and the second reinforcement part comprises a Z-shaped bending structure, extending perpendicular to the pivot axis.

10. A keyswitch structure, comprising:
a base plate;
a keycap; and
a keycap lifting mechanism, the keycap lifting mechanism supporting the keycap above the base plate in a vertical direction, the keycap lifting mechanism comprising:
a first support, the first support comprising a first support body and a first reinforcement part, the first reinforcement part being embedded into the first support body, an elastic modulus of the first reinforcement being greater than an elastic modulus of the first support body; and
a second support, the second support and the first support being pivotally connected around a pivot axis;
wherein the first reinforcement part comprises a Z-shaped bending structure, and the Z-shaped bending structure extends parallel to the pivot axis.

11. A keycap lifting mechanism, comprising:
a first support, the first support comprising a first support body and a first reinforcement part, the first reinforcement part being embedded into the first support body, an elastic modulus of the first reinforcement being greater than an elastic modulus of the first support body, the having a sliding shaft and a sliding hole formed beside the sliding shaft, the first reinforcement part surrounding the sliding hole and going through the sliding shaft; and
a second support, the second support and the first support being pivotally connected around a pivot axis.

12. The keycap lifting mechanism according to claim 11, wherein the first reinforcement part comprises a first plate portion and a second plate portion, the first plate portion and the second plate portion are connected to form a through hole, the sliding hole is located inside the through hole, and the second plate portion goes through the sliding shaft.

13. The keycap lifting mechanism according to claim 12, wherein the first plate portion is exposed from the first support body, and the second plate portion is not exposed from the first support body.

14. The keycap lifting mechanism according to claim 12, wherein the first plate portion and the second plate portion are not coplanar, the sliding shaft extends parallel to the pivot axis with a non-rectangular cross-section, and a thickness of the sliding shaft gradually decreases in a direction away from the pivot axis.

15. The keycap lifting mechanism according to claim 11, wherein the second support comprises a second support body and a second reinforcement part, the second reinforcement part is embedded into the second support body, an elastic modulus of the second reinforcement is greater than an elastic modulus of the second support body, the second support body has a holder shaft and a holder hole formed beside the holder shaft, and the second reinforcement part surrounds three sides of the holder hole and does not extend into the holder shaft.

16. The keycap lifting mechanism according to claim 11, wherein the second support has a holder shaft, and a shaft diameter of the sliding shaft is greater than a shaft diameter of the holder shaft.

17. The keycap lifting mechanism according to claim 11, wherein the first support as a whole extends along a reference plane, the first support body has an upper surface and a lower surface in a direction perpendicular to the reference plane, and the first reinforcement part is exposed from the upper surface and not exposed from the lower surface.

18. A keyswitch structure, comprising:
a base plate;
a keycap; and
a keycap lifting mechanism, the keycap lifting mechanism supporting the keycap above the base plate in a vertical direction, the keycap lifting mechanism comprising:
a first support, the first support comprising a first support body and a first reinforcement part, the first reinforcement part being embedded into the first support body, an elastic modulus of the first reinforcement being greater than an elastic modulus of the first support body, the having a sliding shaft and a sliding hole formed beside the sliding shaft, the first reinforcement part surrounding the sliding hole and going through the sliding shaft; and
a second support, the second support and the first support being pivotally connected around a pivot axis;
wherein the first support is slidably and rotatably connected to the keycap through the sliding shaft.

19. The keyswitch structure according to claim 18, wherein the keyswitch structure has a long side direction and a short side direction, the long side direction is parallel to the pivot axis, the second support has a holder shaft and a holder hole formed beside the holder shaft, the second support is rotatably connected to the keycap through the holder shaft, the keycap has a first long side edge and a second long side edge, the first long side edge and the second long side edge are parallel to the long side direction, there is a first distance in the short side direction between a projection of the sliding hole in the vertical direction and a projection of the first long side edge in the vertical direction, there is a second distance in the short side direction between a projection of the holder hole in the vertical direction and a projection of the second long side edge in the vertical direction, and the first distance is greater than the second distance.
